(19) United States
(12) Patent Application Publication
(10) Pub. No.: US 2008/0313557 A1
(43) Pub. Date: Dec. 18, 2008

(54) System and Methods for Diagnosing and Managing Organization Change

(75) Inventor: Richard A. Kass, Stanford, CA (US)

Correspondence Address: GEORGE MACK RIDDLE, 30 GREENFIELD DRIVE, MORAGA, CA, 94556, US

(73) Assignee: CHANGEANALYTIX, INC., Palo Alto, CA (US)

(21) Appl. No.: 12/131,813

(22) Filed: Jun. 2, 2008

Related U.S. Application Data
(60) Provisional application No. 60/944,771, filed on Jun. 18, 2007.

(51) Int. Cl. G06F 3/048

(52) U.S. Cl. 715/765

(57) ABSTRACT

A system and methods for diagnosing and managing organizational change. A method for diagnosing solutions to organizational performance issues comprises: receiving a list of issues which affect performance of an organization; in response to user input selecting a predefined category for each issue, generating a diagnostic chart including each issue in a column corresponding to the selected category; creating arrows connecting issues on the diagnostic chart based on user input specifying causal connections between issues; in response to user selection of a particular issue on the diagnostic chart, displaying a theme chart including all issues from the diagnostic chart connected to the particular issue; identifying a direct connection arrow between a first issue and second issue on the theme chart which are already connected indirectly through one or more other issues; and automatically removing from display the direct connection arrow, so as to clarify information displayed to the user.

### CROSS REFERENCE TO RELATED APPLICATIONS

The present application is related to and claims the benefit of priority of the following commonly-owned, presently-pending provisional application(s): application Ser. No. 60/944,771 (Docket No. SA/0001.00), filed Jun. 18, 2007, entitled “Systems and Methods for Diagnosing and Managing Organizational Change”, of which the present application is a non-provisional application thereof. The disclosure of the foregoing application is hereby incorporated by reference in its entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

1. Field of the Invention

The present invention relates generally to organizational change management and, more particularly, to systems and methods for assisting users and organizations in diagnosing organizational problems and implementing organizational change.

2. Description of the Background Art

In the fast changing global economy, organizations are increasingly under pressure to operate more efficiently and, when problems arise, to operate quickly to address such problems. Over a period of time problems occur in every organization. These problems typically vary in both source and complexity. Some are long-lived and difficult to eliminate while others seem to appear overnight. When organizations encounter malfunctions, problems or crisis situations, it is often difficult for management to identify what specific things need to be changed within the organization. Once problems are identified it frequently is also difficult to determine how best to go about making the needed change.

Organizations frequently spend a great deal of time identifying and dealing with these change questions. An organization's ability to be successful is often directly related to how effective it is at identifying problem areas and implementing change in a managed and systematic fashion. This necessitates that management of the organization be able to diagnose their core problems in real time, identify their organizational latent weaknesses, plan and launch appropriate change initiatives and implement corrective actions.

In many cases, management engages outside experts (e.g., management consultants) to assist in change initiatives due to actual or perceived lack of experience internally within the organization. However, many change initiatives, including those led by outside experts, are not successful. It is estimated that 70 percent of change initiatives by Fortune 100 companies do not reach their objectives. M. Beer and N. Nohria, “Cracking the code of change” Harvard Business Review on Turnarounds, p. 1, 1997. Reasons for failure of such change initiatives include lack of communication with, and buy-in by, stakeholders within the organization. Another problem is the lack of tools and systems to help organizations collect, sort and organize data gathered regarding organizational problems, diagnose organization problems, plan and implement change activities and track actions that have been taken. As the need for faster problem diagnosis and intervention increases, both managers and business advisors increasing are looking for tools to assist them in navigating complex organizational interrelationships and implementing change initiatives.

Existing business intelligence solutions typically focus on the analysis of numerical data and information. This information, while useful for system management and a number of other activities, is not as helpful in diagnosing organization problems as the collected numerical information is primarily reflective of results (or symptoms) of the problems the organization is experiencing. These solutions typically are not helpful in identifying the underlying organizational problems nor do they assist in developing solutions for correcting such problems.

What is needed is a solution that enables stakeholders in an organization to collect data that is useful for identifying underlying organizational problems and assist them in implementing appropriate solutions to such problems. The solution should assist users in analyzing complex organizational interrelationships and turning their collected data and information into organizational knowledge, so as to enable the organization to take appropriate action in implementing organization change. The present invention provides a solution for these and other needs.

### SUMMARY OF INVENTION

A system and methods for diagnosing and managing organizational change is described. In one embodiment, for example, a method of the present invention is described for assisting a user in diagnosing solutions to issues affecting performance of an organization, the method comprises steps of: receiving a list of issues which affect performance of an organization; in response to user input selecting a predefined category for each issue on the list, generating a diagnostic chart including each issue in a column corresponding to the selected category; creating arrows connecting issues on the diagnostic chart based on user input specifying causal connections between issues; in response to user selection of a particular issue on the diagnostic chart, displaying a theme chart including all issues from the diagnostic chart connected to the particular issue; identifying a direct connection arrow between a first issue and second issue on the theme chart which are already connected indirectly through one or more other issues; and automatically removing from display the direct connection arrow, so as to clarify information displayed to the user.

### BRIEF DESCRIPTION OF DRAWINGS

FIG. 1 is a very general block diagram of a computer system (e.g., an IBM-compatible system) in which software-implemented processes of the present invention may be embodied.

FIG. 2 is a block diagram illustrating an environment in which the present invention may be implemented.

FIGS. 3A-B comprise a single high level flow diagram illustrating the Stream Diagnosis process and methodology for diagnosis of organizational problems.

FIG. 4A is a bitmap screenshot of the Stream Diagnostic Module main screen of the currently preferred embodiment of the present invention.

FIG. 4B is a bitmap screenshot showing the Issue List window of the Stream Diagnostic Module.

FIG. 4C is a bitmap screenshot showing an example Diagnostic Chart.

FIG. 4D is a bitmap screenshot showing the example Diagnostic Chart of FIG. 4C after sorting.

FIG. 4E is a bitmap screenshot illustrating a Linkage Chart window of the Stream Diagnostic Module.

FIG. 4F is a bitmap screenshot illustrating a Create Theme Chart dialog box.

FIG. 4G is a bitmap screenshot illustrating an example Theme Chart.

FIG. 4H is a bitmap screenshot illustrating the example Theme Chart of FIG. 4G after the hide shortcuts feature of the present invention has been invoked.

FIG. 4I is a bitmap screenshot showing a Theme Chart Summary window.

### DETAILED DESCRIPTION

### Glossary

The following definitions are offered for purposes of illustration, not limitation, in order to assist with understanding the discussion that follows.

Arrow: In the presently preferred embodiment of the Stream Diagnostic Module, arrows are used to show key interconnections (causal relationships) between issues.

Boxes or Issue Boxes: Boxes are used to depict issues on the Diagnostic Chart in the currently preferred embodiment. In operation, users create a box including an issue and place the issue box in one of the Stream categories (columns) on the Diagnostic Chart.

Core Problem: A problem that drives (causes) many other problems in the organization.

Destination Box: Represents a box containing an issue that is driven by (caused by) another issue.

Diagnostic Chart: The Diagnostic Chart is a pictorial representation of organizational problems generated by the Stream Diagnostic Module based on organizational issues and user input as to categorization of such issues and interconnections (relations) with other issues. The Diagnostic Chart is currently divided into columns (Stream categories), with one column for each organizational dimension.

Discussion File: Refers to a file or location for users to place information (e.g., statements) gathered in interviews, through questionnaires or from other sources and that are used to clarify issues.

Information Bar: Used as a guide to assist users in entering information into the Diagnostic Chart (e.g., informing users if they are performing a step incorrectly or out of sequence).

Interviews: One of the typical steps in the Stream Diagnostic process used to gather information about how an organization is malfunctioning.

Issues: Identifiable problems that are blocking an organization's effective performance.

Issues List: A list of identifiable problems (issues) input by users and displayed on screen by the Stream Diagnostic Module.

Interconnections: Causal relationships between issues in the Stream categories.

Linkages: Strings of interconnected issues illustrated by arrows showing direction of causality.

Linkages Chart: A chart displayed by the Stream Diagnostic Module for organizing issues extracted from the Diagnostic Chart in a way that highlights strings of interconnected issues.

Questionnaire: One of the typical steps in the Stream Diagnostic process used to gather information about how an organization is malfunctioning.

Organizing Arrangements: Organizing Arrangements are formal descriptions of the way the organization is supposed to work. Organizing Arrangements refers to all parts of the organization that formally coordinate the behavior of people and the functioning of various parts of the organization. Typical components of Organizing Arrangements are goals, strategies, formal structure, administrative policies and procedures, administrative systems and reward systems. Organizing Arrangements also refers to a default Stream category on the Diagnostic Chart.

Physical Setting: Physical Setting includes the concrete structures and objects of the nonsocial/non-technical part of the environment in which people work. Four of the main components of Physical Setting are: 1) space configuration, 2) physical ambience 3) interior design, and 4) overall architectural design. Physical Setting also refers to a default Stream category on the Diagnostic Chart.

Social Factors: Social Factors include all things directly related to people in the organization, including their characteristics (individually and in small groups), their patterns and processes of interaction, and their features as larger social groups. Social Factors has traditionally been called the informal organization in contrast to the Organizing Arrangements which have been considered the formal side. Components of Social Factors include attitude, interaction processes, social patterns and networks and individual attributes. Social Factors is also one of the default Stream categories on the Diagnostic Chart.

Sort: A feature provided in the currently preferred embodiment of the present invention which can be used to simplify the complexity of the Diagnostic Chart by directing core problems to the top of the chart and symptomatic problems to the bottom.

Source Box: Represents a box containing an issue that is driving (causing) one or more other issues as illustrated by an arrow directed from the source box to one or more destination boxes.

SQL: SQL stands for Structured Query Language. The original version called SEQUEL (structured English query language) was designed by IBM in the 1970's. SQL-92 (or SQL/92) is the formal standard for SQL as set out in a document published by the American National Standards Institute in 1992; see e.g., “Information Technology—Database languages—SQL”, published by the American National Standards Institute as American National Standard ANSI/ISO/IEC 9075: 1992, the disclosure of which is hereby incorporated by reference. SQL-92 was superseded by SQL-99 (or SQL3) in 1999; see e.g., “Information Technology—Database Languages—SQL, Parts 1-5” published by the American National Standards Institute as American National Standard INCITS/ISO/IEC 9075-(1-5)-1999 (formerly ANSI/ISO/IEC 9075-(1-5) 1999), the disclosure of which is hereby incorporated by reference.

Stream categories: Organizational problems identified by users are grouped into Stream categories based on issue type. In the presently preferred embodiment, issues (i.e., organizational problems on an issue list) are displayed in columns on the Diagnostic Chart based on the Stream category of such issue specified by a user.

Technology: Technology of the organization includes all factors that directly enter into the transformation of organizational inputs into organizational outputs. The organizational dimension of Technology includes the tools, equipment and machinery used in the transformation process, designs of jobs required to perform that transformation, work flow design technical procedures, technical systems, and technical expertise of organizational members. Social Factors is another of the default Stream categories on the Diagnostic Chart.

Theme: A set of related (or connected) issues from the Diagnostic Chart organized around a particular topic.

Theme Chart: A chart which can be used to identify interconnections among categorized issues.

Theme Summary: A chart that lists Themes that have been determined from interconnected issues.

Title Bar: In the currently preferred embodiment, the title bar contains titles of categories (columns) in the Steam Diagnostic Chart. Titles can be changed through use of a Utilities menu.

### Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows® operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

### Computer-Based Implementation

Basic System Hardware and Software (e.g., for Desktop and Server Computers)

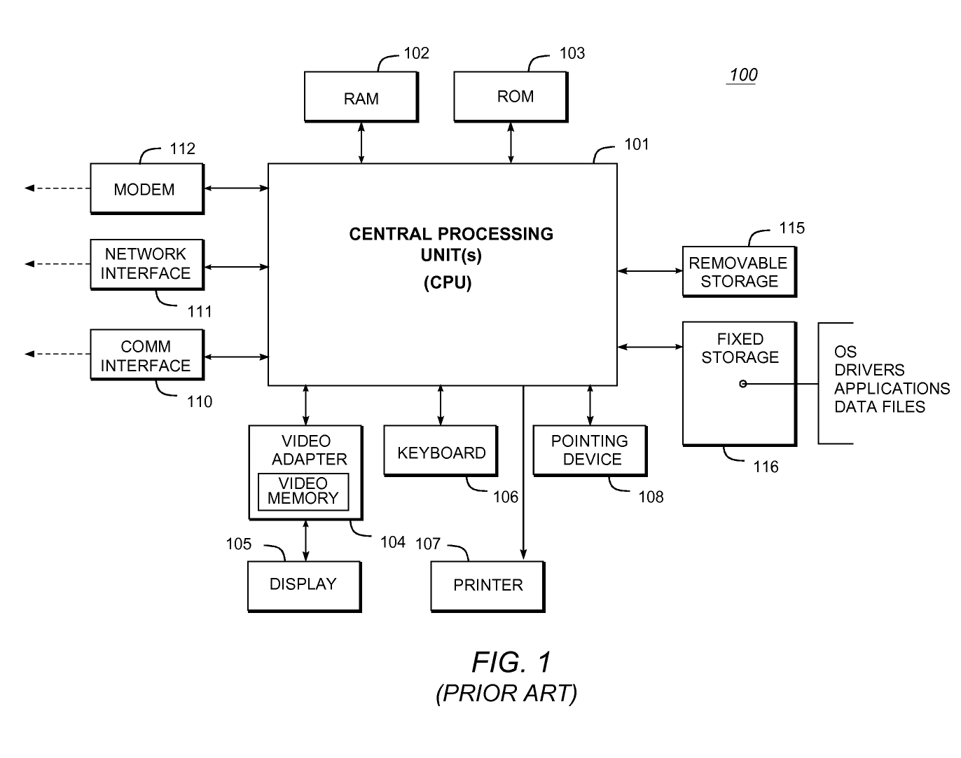

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, a HP LaserJet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56 K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying desktop and server computer components that may be employed for implementing the present invention. The present invention, however, is not limited to any particular environment or device configuration. Instead, the present invention may be implemented in any type of system architecture or processing environment capable of supporting the methodologies of the present invention presented in detail below.

### Overview of System and Methodology for Diagnosing and Managing Organizational Change

The present invention provides a system and methodology enabling organizations to rapidly uncover core organizational issues and their interdependencies, in order to help stakeholders collaboratively arrive at corrective actions that directly address the impediments to positive change. Instead of a “top down” approach, it uses an alternative technique referred to as “Stream Analysis” for discovering core problems that stand in the way of getting optimal results for projects, initiatives, and organizational effectiveness. The Stream Analysis approach is based in part on work which was originally developed by Professor Jerry Porras of the Stanford Graduate School of Business (see e.g., Porras, J. “Stream Analysis, a Powerful Way of Diagnosing and Managing Organizational Change”, Addison-Wesley OD Series, 1987). The present invention is currently included as a component of a Stream Diagnostic solution which provides automated tools and utilities which assist managers with diagnosing organizational problems and managing organizational change. The solution can be used to generate alignment among managers not only on problem diagnosis, but more significantly, on problem solutions. The system and methodology of the present invention provides the stakeholders of an organization with the means for turning data into rational information, identifying core issues, and making informed course corrections.

In its presently preferred embodiment the solution includes tools to help users collect data on organizational problems and then sort and organize the collected data. Once data on organizational problems is collected, tools and utilities provided by the system of present invention assist users in quickly diagnosing organizational problems, planning specific change activities, implementing these activities and tracking the actions that are taken. The system and methodology of the present invention supports performance of the following three high level phases which are described below in more detail: 1) systematic data collection; 2) distinguishing symptoms from core issues and identifying clusters of inter-related problems; and 3) planning and tracking change.

The present invention is particularly useful in providing users with a graphical way of organizing employee and stakeholder input about organizational problems into a logical structure that assists in distinguishing symptoms from core issues that need to be addressed to effectively implement lasting change. The solution assists users in understanding key issues impacting organizational performance and identifying productive solutions. The system allows complex relationships to broken down into subsets and automatically removes extraneous or less significant information about the relationships between problems, thereby enabling users to better focus on core issues and how such issues may be addressed. The solution can be used in a wide range of organizations, including government and business organizations. It can also be used by at all levels of these entities, including by project leaders, business managers, organizational advisors, governance and oversight teams. The typical phases of the Stream Analytics methodology of the present invention will next be described in more detail.

### Stream Analysis Phases

The Stream Analysis methodology of the present invention generally involves three general phases which typically include the activities described below.

Phase 1—Systematic Data Collection:

Generating data (e.g., from questionnaires, interviews, observation, examination of records).
Summarizing qualitative data
Sorting qualitative data into clusters
Identifying summary and backup issues from data
Displaying issues in concise form

Phase 2—Diagnosis

Entering issues into Issues List
Categorizing Issues into Stream Diagnostic Chart
Identifying key interconnections among categorized problems

### Analyzing the Stream Diagnostic Chart

Distinguishing symptoms from core issues

### Creating Themes

Phase 3—Planning Intervention/Tracking Change

Planning necessary organizational change
Taking actions to intervene/address problems (i.e., implementing organizational change)
Tracking information describing what actually happened in response to the action rather than what was planned

The Stream Analysis solution includes tools which assist users in implementing the Stream Analysis approach to organizational change. The solution includes features which help individuals or teams uncover failings in organizational functioning and lay the foundation for planned organizational change. The following is a brief description of the modules provided in the currently preferred embodiment for use in diagnosing and implementing organizational change.

### System Components

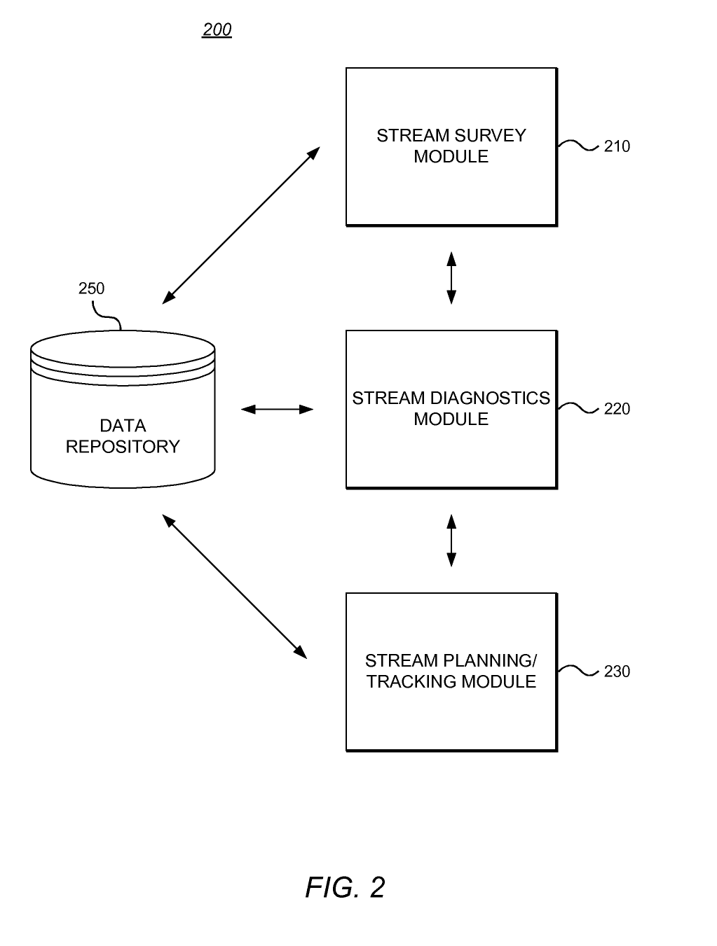

FIG. 2 is a block diagram illustrating an environment 200 in which the present invention may be implemented. As shown, the environment 200 includes a Stream Survey Module 210, a Stream Diagnostic Module 220, a Stream Planning/Tracking Module 230 and a Data Repository 250.

The Stream Survey Module 210 includes a bank of questions divided into categories. A user or team may select questions from a question bank. After questions have been selected, the Stream Survey Module 210 automatically formats the selected questions into a questionnaire, which may be then distributed to managers, employees and other stakeholders in the organization for collecting their input. The Stream Survey Module includes functionality for processing and tabulating completed questionnaires. In addition, import features make it possible to input data files in various formats (e.g., data files written using other software products). The input data is stored in the Data Repository 250. It should be noted that data may be input through a number of means and the use of questionnaires is not required by the present invention. After data has been imported, the Stream Survey Module 210 summarizes the collected data, generates statistics and inserts bar graphs and significance indicators to highlight areas of special importance. In addition to tabulating numerical responses, the system also processes qualitative verbatim comments as these comments often offer valuable insight into what numerical responses may really mean. The Stream Survey Module sorts comments into coherent clusters and then automatically labels these clusters. The Stream Survey Module 210 also assists in identification of summary and backup issues (described in more detail below). These issues serve as a basis for action planning and/or undergo further analysis using the Stream Diagnostic Module 220. The Stream Survey Module displays the results generated from the collected data in a concise and easy-to-digest format. A user may select from several available formats for display of the information.

The Stream Diagnostic Module 220 is used to diagnose organizational problems based on collected information regarding such problems (e.g., information gathered using the Stream Survey Module 210 or through other means). The Stream Diagnostic Module 220 includes functionality which enables users or teams to assign issues to organizational categories or “Streams”. Currently, the solution provides (by default) for four organizational Streams which are referred to as “Organizing Arrangements”, “Social Factors”, “Technology” and “Physical Settings”. These default categories have been selected to reflect behavior based on system theory and social cognitive theory. However, organizations, teams and individuals may designate their own organizational Streams (i.e., categories) for use in organizing and displaying the collected data, if desired. In correctly assigning issues to organizational Streams, a team must consider issues in sufficient depth such that a shared meaning is achieved. The Stream Diagnostic Module 220 also provides for creating interconnections between issues. After issues have been assigned to organizational Streams, the next step of analysis typically involves identifying causal connections or “linkages” between issues. The Stream Diagnostic Modules provides several features for assisting users in this process. These features assist teams in developing shared assumptions and reinforces the idea that issues typically have multiple causes and effects.

In order to effectively implement organizational change, addressing problems at the core level is generally more productive than simply attacking symptoms. Since these core level issues drive many other issues, a tremendous amount of leverage can be gained by resolving them. The Stream Diagnostic Module 220 assists users and teams in distinguishing between symptoms and the core problems that are causing such symptoms through a diagnosis process which is described in detail below. The Stream Diagnostic Module includes features which allows users or teams to organize issues together to create “Themes”. A “Theme” is a cluster of issues strung together that, when taken as a group, describe a more complex issue in the organization. The Stream Diagnostic Module facilitates the identification of these Themes, which enables related issues to be addressed in a more comprehensive fashion. It also includes several features which assist users in isolating problems which are candidates for organizational intervention (change initiatives).

The Stream Planning/Tracking Module 230 assists an organization in the process of implementing change. Changing an organization is a complex process that often results in much confusion. The Stream Planning/Tracking Module 230 assists in reducing such confusion by showing a clear mapping from issues to actions. Stream tracking features also enable actions taken to be systematically charted. By comparing this record with the original plan, an organization can better learn how to change itself and hence, be more effective in future change activities.

The Data Repository 250 (which may represent a database or a plurality of databases) provides database support to the system, storing questions, questionnaire responses, issues, connections, and other related information. The issues, Diagnostic Charts, connections (linkages), Themes, and other information generated using the Stream Survey Module 210, the Stream Diagnostic Module 220 and/or the Stream Planning/Tracking Module 230 are stored in the Data Repository 250. Optionally, the information in the Data Repository 250 may also be available in response to Structured Query Language (SQL) queries.

### Stream Diagnostic Process

Overview of Stream Diagnostic Process

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

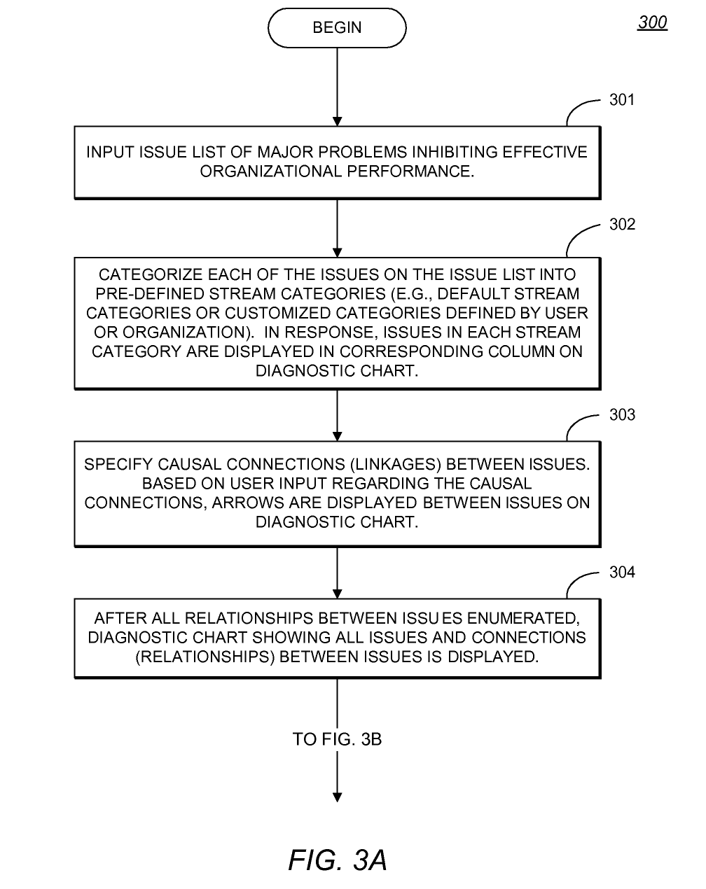

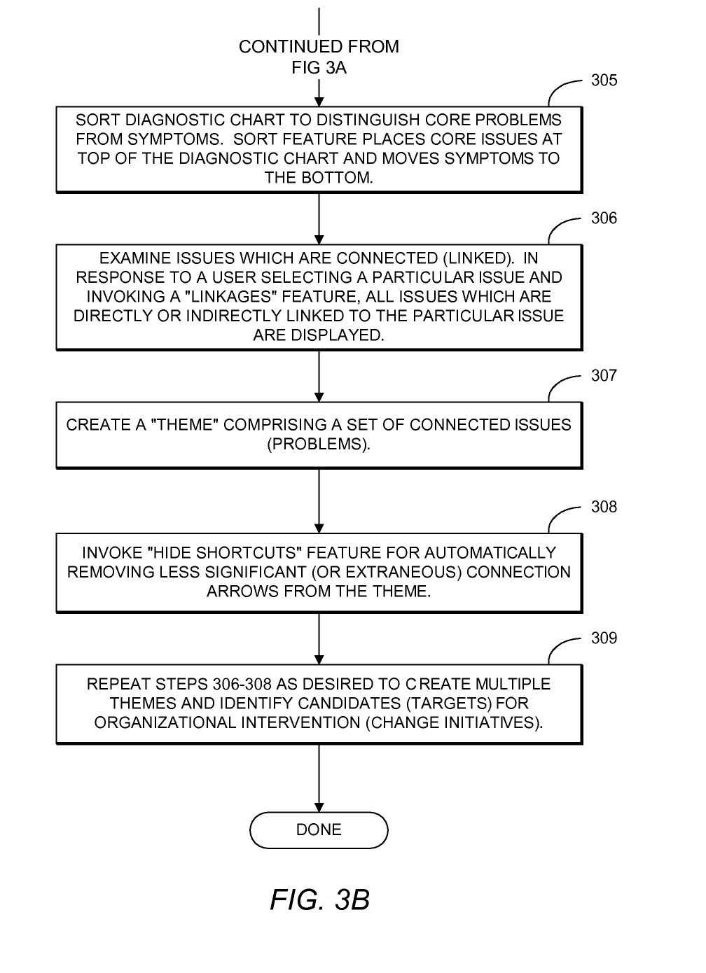

FIGS. 3A-B comprise a single high level flow diagram 300 illustrating the typical Stream Diagnosis process and methodology for diagnosis of organizational problems. This flow diagram 300 corresponds to the second phase of Stream Analysis as it assumes that data on organizational problems has already been collected and used to generate a list of issues believed to be impacting organizational performance. Typical sources of information include surveys of employees and/or managers, questionnaire responses, focus groups, suggestion boxes, input of a set of managers in the organization with experience regarding its problems, analysis an observations of outside consultants, or a combination of these and other similar measures for obtaining input as to organizational problems. In collecting this information the Stream Survey Module may (optionally) be used. It should be understood that the following steps may be performed in a different sequence and/or various steps may be repeated and/or other modifications made. Thus, the following is for purpose of illustrating the basic operations that may be performed as part of the diagnostic process and should not be construed as limiting these operations to the specific sequence indicated.

The process begins with input of an “Issue List” comprising a list of the major problems inhibiting effective organizational performance as shown at step 301 at FIG. 3A. The creation of the Issue List typically involves analyzing collected information to identify particular issues affecting organizational performance (e.g., problems mentioned in multiple responses or other sources of input). This may involve a number of drafts and additional feedback until consensus among a group creating the Issue List is reached. The identified problems are then included in an Issue List which is input into Stream Diagnostic Module. At the outset the issues on the Issue List can be in random order and all of the interrelationships (causal connections) between issues have typically not yet been specified. It should be understood that comments and other background material collected relating to a particular issues may indicate that the issue is related or connected to one or more other issues. However, when the list of issues is input into the Stream Diagnostic module of the present invention, the above-described causal connections between issues (which are to be represented by arrows on the Diagnostic Chart) may not yet have been specified or determined.

At step 302, each of the issues on the Issue List are categorized into pre-defined Stream categories based on user input. In response, issues in each of the Stream categories are displayed in a corresponding column on the Diagnostic Chart of the present invention as hereinafter described in more detail. In the presently preferred embodiment, there are four default Stream categories displayed on the Stream Diagnostic Chart of the present invention: Organizing Arrangements, Social Factors, Technology and Physical Settings. A user or organization may elect to use different categories which are more appropriate to their particular organization rather than these default categories, if desired. In addition, although the currently preferred embodiment provides (by default) for use of four categories, those skilled in the art will appreciate that a greater (or lesser) number of categories may be utilized if desired.

After issues in the Issue List have been categorized, at step 303 the causal connections (linkages or inter-relationships) among issues are determined. In its currently preferred embodiment, the present invention provides three approaches for users to examine issues and specify causal connections between them which are referred to as the Holistic, Box Pair and Arrow Chain methods. Based on user input regarding the relationship among issues, arrows are placed between issues on the Diagnostic Chart. An arrow directed from a first (or source) issue box to a second (or destination) issue on the Diagnostic Chart represents that first issue is driving (i.e., causing or contributing to) the second issue. (Although not shown as a separate step at FIGS. 3A-B, categorization of issues and connections among issues are frequently reviewed and refined several times by a user or team). After all relationships between issues have been enumerated, the initial phase of Stream Diagnosis is complete and a Diagnostic Chart showing all issues and their relationships is displayed as indicated at step 304.

The second phase of the Stream Diagnosis process involves working with the information displayed on the Diagnostic Chart so as to distinguish core problems from symptoms and to identify those problems that are good targets for change initiatives. Several features of the present invention may be used to organize, simplify and/or create subsets of the Diagnostic Chart to enable users to better understand the relationship among particular problems so as to facilitate identification of targets for change initiatives. One of these features is a sort feature for sorting the Diagnostic Chart as illustrated at step 305 at FIG. 3B. A sort feature of the present invention, when invoked, places core issues at the top of the Diagnostic Chart and moves symptoms to the bottom of the Diagnostic Chart. This assists users in identifying core problems and distinguishing them from symptomatic problems.

At step 306 users may examine issues which are connected (i.e., linked) to analyze relationships among issues. As described below in more detail, a user may select a particular issue on the Diagnostic Chart and invoke a “Linkages” feature of the present invention to display issues which are connected. In response, other issues which are linked, directly or indirectly, to the particular issues are displayed. (Alternative means are also available for creating a subset of related issues as described below.) Other issues on the Diagnostic Chart which are not connected to the particular issue will not be displayed. A user may, however, link additional issues to those displayed, if desired (e.g., by adding connections to additional issues on the Diagnostic Chart).

A user may then choose to create a “Theme” comprising a set of related issues as indicated at step 307. In creating a Theme a user may remove one or more of the linked issues and/or may modify or remove connections among issues, as desired. The creation of Themes allows users to formulate a clearer plotline of problem Themes which may be targets for organizational intervention. At step 308, a “hide shortcuts” feature, when invoked by a user, automatically removes less significant (or extraneous) connection arrows from a Theme so as to display the connections among issues in a more clear and understandable manner. The hide shortcut feature enables further simplification and consolidation of connections among issues (e.g., issues of a given Theme created as described above). Although extraneous connection arrows are generally removed, an exception is made for arrows emanating from core issues as this information is generally viewed by users as very important. As indicated at step 309, steps 306-308 may be repeated as desired to create multiple Themes and identify candidates for intervention (i.e., targets for organizational change initiatives). Themes that are created in this fashion can then be saved so that they can be displayed again as hereinafter described.

A user, team or organization can then use the information to plan and implement organizational change to target the specific problems which are identified and diagnosed through the above process. The Stream Planning/Tracking Module may (optionally) be used to assist in implementing such actions and tracking progress. The following will describe the Stream Diagnosis process in more detail and the features provided by the present invention to assist users in the process of diagnosing organizational problems and implementing change. The following discussion will focus on the use and operations of the currently preferred embodiment of the Stream Diagnostic Module in which the system and methodology of the present invention is implemented.

Collecting Organizational Information

Generally, gathering information about organizational problems is a pre-requisite for the use of the Stream Diagnostic Module. The process of data collection may include use of questionnaires, interviews and other data collection methods as previously described. This information can be collected using the Stream Survey Module or through other means. After the data is collected, it typically is summarized and organized and used to identify a set of issues or problems which may then be examined using the Stream Diagnostic Module.

Entry of Issues into Issues List

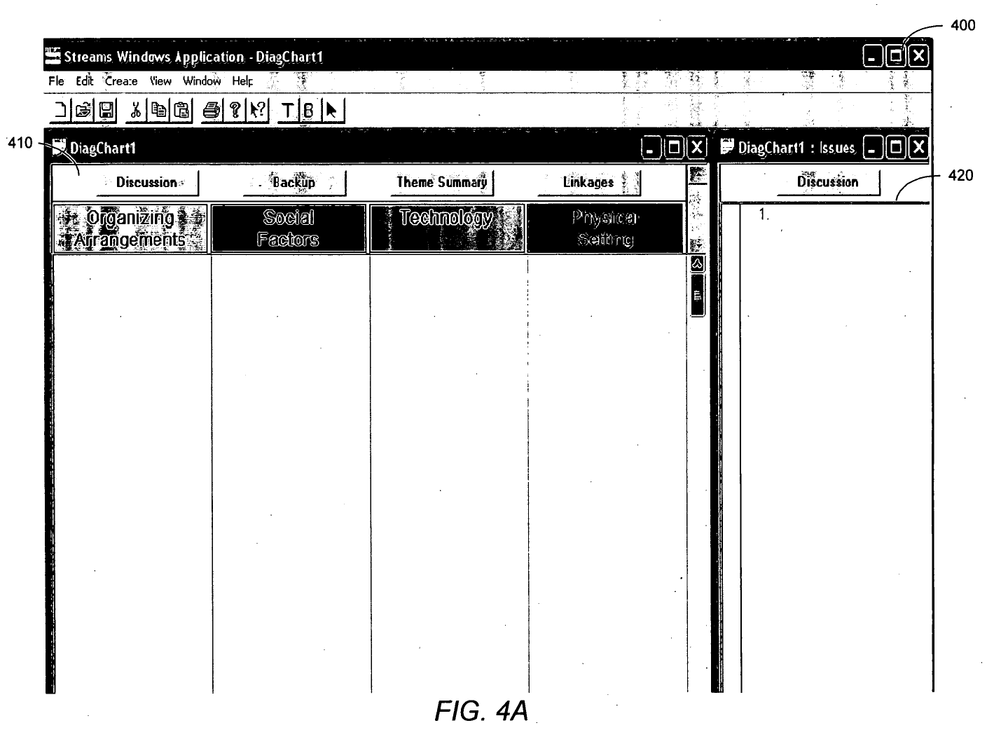

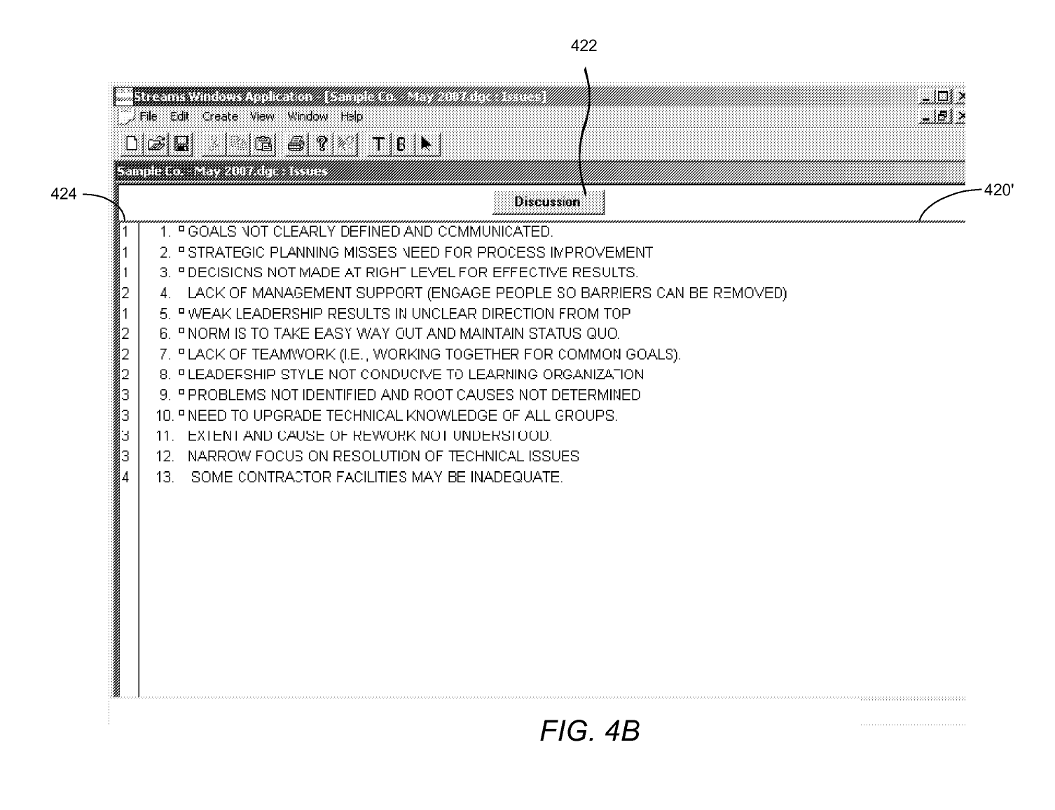

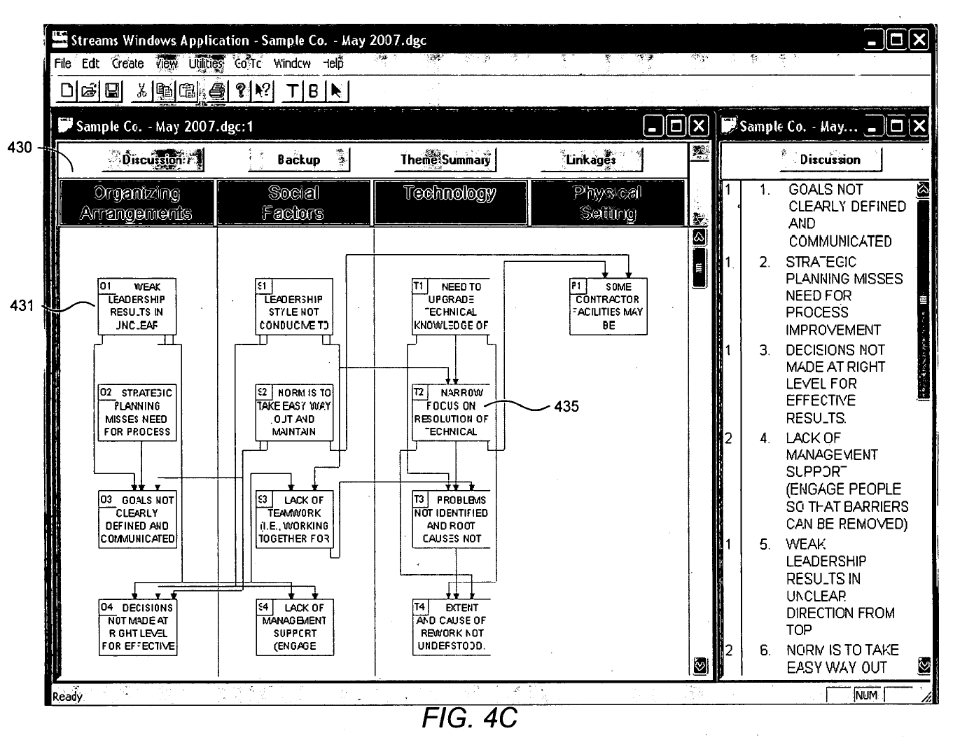

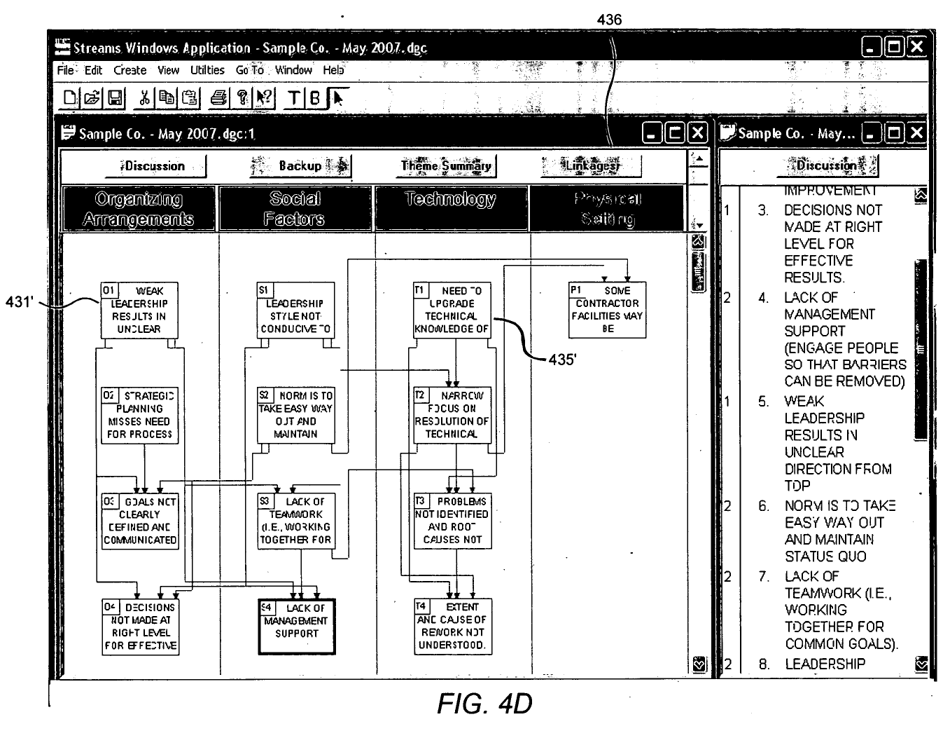

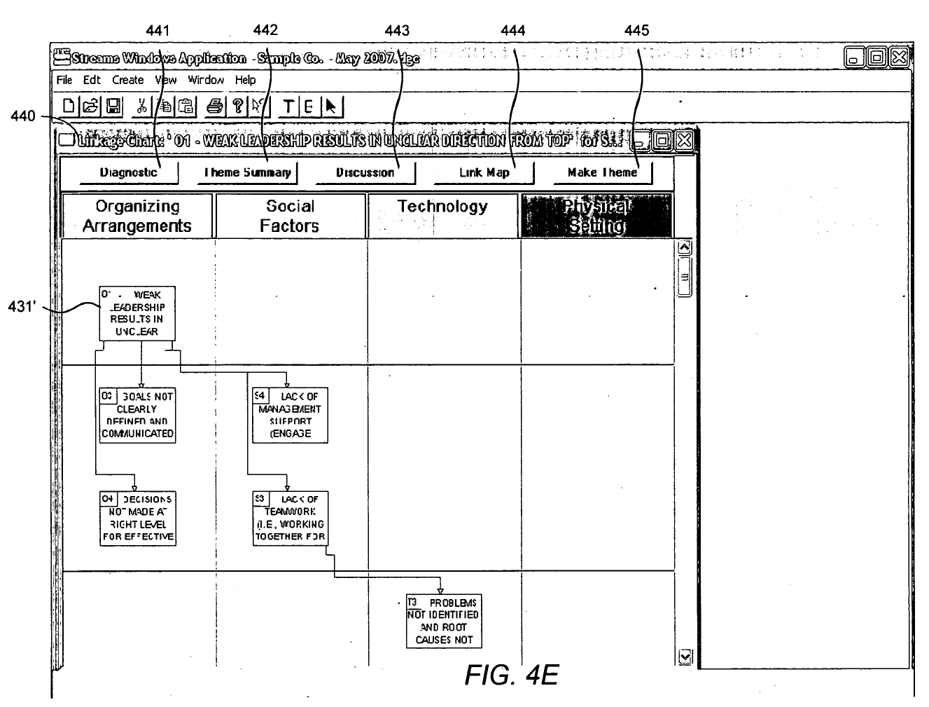

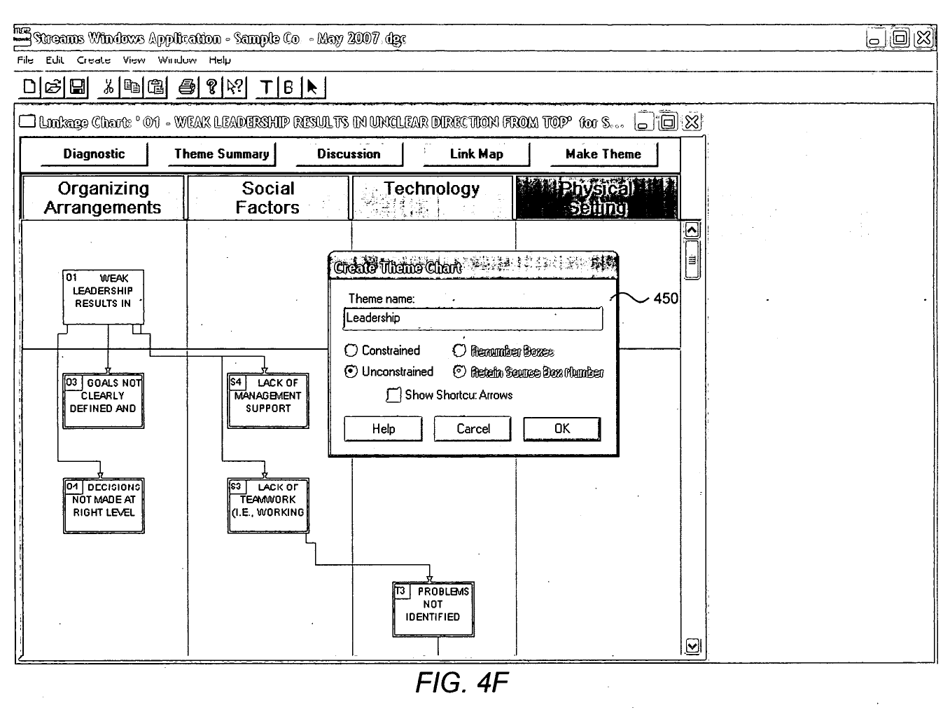

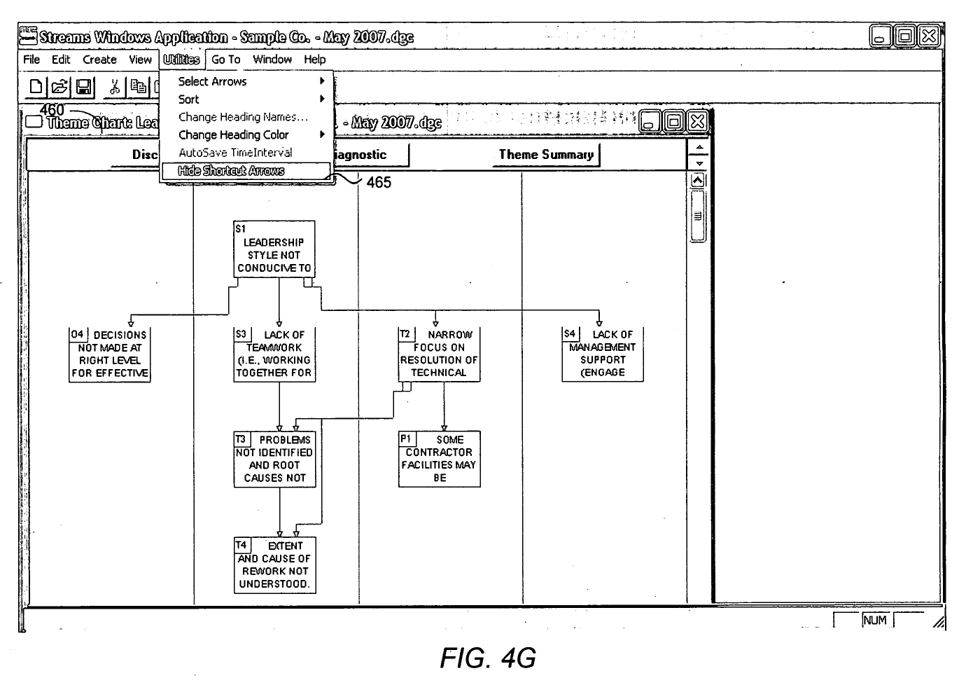

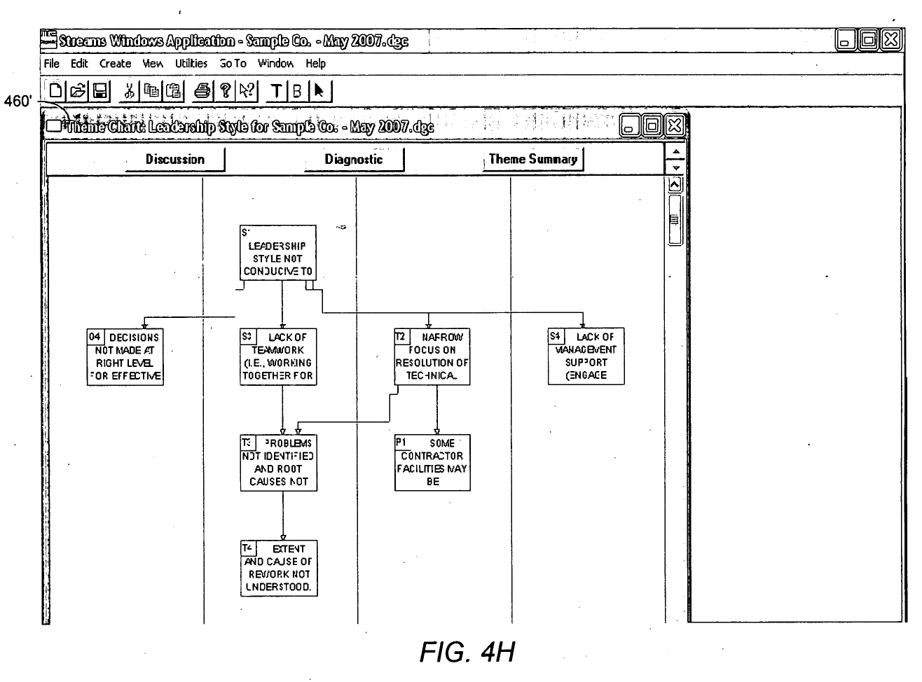

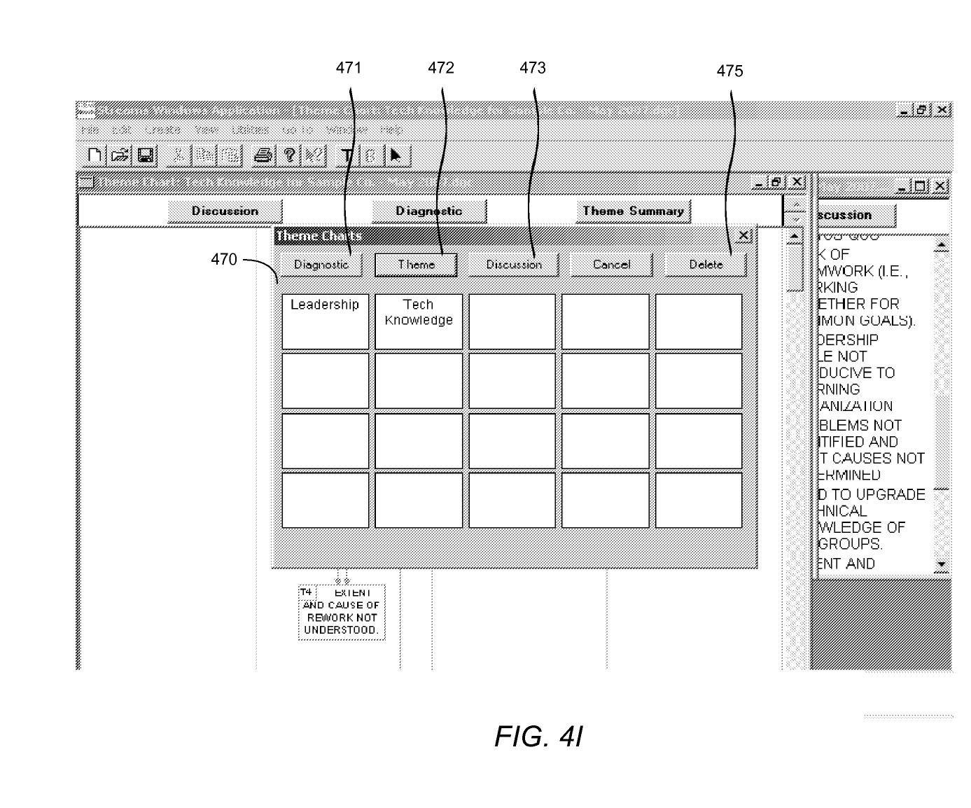

The Stream Diagnostic process typically begins with entry of a list of issues (referred to as an “Issue List”) which have been determined from the collected organizational information. This list of issues is input and displayed in an Issues List window of the Stream Diagnostic Module. FIG. 4A is a bitmap screenshot of the Stream Diagnostic Module main screen 400 of the currently preferred embodiment of the present invention. As shown, the main screen 400 includes a Stream Diagnostic Chart 410 and an Issues List 420. In the presently preferred embodiment, the Issues List window 420 appears with the Diagnostic Chart 410 when the Stream Diagnostic Module is first opened. As shown at FIG. 4A, the Issues List 420 is in the background and partially overlapped by the Diagnostic Chart 410. The Diagnostic Chart contains (default) Stream columns titled Organizing Arrangements, Social Factors, Technology, and Physical Settings.

FIG. 4B is a bitmap screenshot showing the Issue List window (now 420′) of the presently preferred embodiment of the Stream Diagnostic Module. FIG. 4B shows the Issue List window after it is brought into the foreground and issues have been entered so as to create an Issues List. Information may be entered into the Issues List window 420′ by typing entries into the list, by cutting and pasting information from other files or through other input mechanisms (e.g., input from Stream Survey module or database import). Issues on the Issue list can also be edited as hereinafter described.

Backup Material for Issues List

The Stream Diagnostic Module also offers an easy mechanism for entering backup material in support of individual issues in a “Discussion File”, if desired. The Discussion File provides easy access to the backup material relating to ach of the issues, enabling users to obtain additional information about issues on the Issue List. A user or team may have some information such as a quote that supports an issue entered in the Issues List. The Discussion File can be used for holding quotes, graphics, statistics, or any other example or information that will provide support information for a particular issue. A Discussion File can also be used to clarify, refine and consolidate possible issues before they are entered on the Issues List. For example, survey results may reveal a cluster of issue statements that seem closely related. By placing this information together in a single Discussion File, duplications become apparent and new issues are identified. The Discussion File can be accessed through the Issues List through the Discussion button 422 as shown at FIG. 4B. The Discussion File can also be accessed through the Diagnostic Chart. A user can also add supporting information to an issue already entered by clicking on (selecting) the Discussion button 422 at the top of the Issues List as shown at FIG. 4B.

Categorizing Issues

After issues have been entered into the Issues List, the next step in the diagnostic process is to transfer the issues into the Stream Diagnostic Chart(s). Prior to entering issues into Stream columns, however, it must first be determined which Stream column (category) is appropriate for each issue. In the currently preferred embodiment, the default Stream column titles are “Organizing Arrangements”, “Social Factors”, “Technology” and “Physical Setting”. A user or organization may easily customize the Stream column title or use the default titles/categories, as desired. Users are, however, advised to use care in creating customized categories as using inappropriate categories can reduce the effectiveness of the diagnostic process (i.e., not generate good results). In categorizing an issue, users may consult the Discussion List and other information (e.g., survey results, quotations, interviews, etc.) in order to properly categorize the issue.

Entering Issues on Diagnostic Chan

Once an issue has been categorized, the issue can be entered into boxes in the appropriate Stream column on the Diagnostic Chart. Whatever titles are selected for the Streams columns for issue placement purposes, the columns are numbered (e.g., four columns are numbered 1 to 4) reading from left to right (e.g., Organizing Arrangements is Stream #1, Social Factors is Stream #2, and so forth as shown at FIG. 4A). This assists users in locating issues, particularly in the case of large Diagnostic Charts. On the left of the Issues List 420′ at FIG. 4B is a Stream Number column 424. The Stream Column number column 424 on the Issues List can be used as a short cut for entering issues on the Diagnostic Chart by automatically creating a box for an issue in the appropriate Stream column when a user types in the column number for the issue in the Stream Number column.

The Stream Diagnostic Module allows users to place issues on the chart in one of two ways. The first approach allows a user to select an issue and enter the Stream column number (e.g., in the field 424 as shown at FIG. 4B). In response, the issue is automatically placed in a box in the appropriate Stream column on the Diagnostic Chart. Alternatively, a user can create boxes for issues in each of the Stream categories (columns) by selecting “box” from the Create menu and clicking inside the selected Stream column on the Diagnostic chart. The process may be repeated to place additional boxes in one or more of the Stream columns. Issues may then be typed into the boxes and/or cut and paste from the Issues List window. A user can continue assigning issues to Stream columns (categories) using either (or both) of the above approaches until all issues from the Issues list have bean entered into the Diagnostic Chart.

Working with Issue Boxes

Changing text in the box: Editing of issues can take place either on the Issues List or directly in its box on the Diagnostic Chart. Text changes on the Issues List are immediately reflected on the Diagnostic Chart and vice versa.

Moving Boxes: A box may be moved by clicking on its border to highlight the box and then dragging the box to its new location: up or down, or to another column if the subject is more appropriate in a different Stream column. Boxes can also be moved to a different Stream column using the Issues List by selecting the number corresponding to the issue in the Stream Number column and typing in the new column number.

Changing box size: The standard box size may be reduced so as to display more boxes on screen or may be increased if the size of the box is not sufficient to display the issue text. For example, the size of a box may be reduced to 50% or 25% or may be creased to 150% or to 200% of the standard size by selecting the desired size using a resolution option on the view Menu provided in the presently preferred embodiment. In the presently preferred embodiment the boxes are size limited to ensure that issues are expressed in a concise manner. However, the solution can be easily adapted to allow for issue boxes of various different sizes as desired (e.g., adjusted based on display capabilities of a user's computing system).

Identifying Key Interconnections

After issues have been identified and categorized through entry into the appropriate Stream column, the next step is typically to identify interconnections (i.e., causal connections) among the issues. In this step, the user reviews the issues in each of the Stream columns and determines which are related to each other. Users may consult the Discussion List and other information (e.g., survey results, quotations, interviews, etc.) in this process of identifying connected issues. The process of identifying connections for a particular issue typically involves answering the questions such as the following:
Is a particular issue driving any of the other issues that have been identified?
Is a particular issue being driven by (caused by) another issue?
Are there issues that clearly are not related to each other?

Determining how issues relate to each other will eventually enable users or teams to identify which issues are core issues, which are linking issues, and which issues are really just symptoms. “Core” issues are issues which drive (or cause) many of the other issues in the organization (e.g., other issues depicted on the Diagnostic Chart). “Symptoms” are issues driven by many other issues, but that do not themselves appear to cause many other issues. Linking issues are issues that are both driven by and drive other issues.

In this stage of the Stream Diagnosis process users or teams determine which issues cause (or are caused by) other issues and show these relationships in the Diagnostic Chart. Arrows are used to show how issues are related to each other, with the arrows being directed from the box of the issue causing (driving) another issue to the box of the issue that it is causing. Causal connections are represented on the Diagnostic Chart by arrows going from cause to effect. For example, if a user or team determines that Issue 1 drives or causes Issue 2, this is represented on the Diagnostic Chart by an arrow leaving Issue 1 and entering Issue 2. The following alternative methods for establishing interconnections between issues are supported in the presently preferred embodiment:

1. Holistic Method: The following steps may be performed to connect an issue to another related issue using the “holistic” method:
Choose Arrow from the Create menu;
Click once anywhere inside the source box; and
Click once anywhere inside the destination box.

These steps will cause an arrow to appear which is directed from the source box to the destination box, showing that the issue in the source box drives the issue in the destination box. To eliminate an arrow that has been created, the arrow can simply be selected (e.g., clicking on the point of arrow) and cut (e.g., by choosing “cut: from the Edit menu) or deleted.

2. Systematic or Box Pair Method: To connect issues using the “systematic” or “box pair” method, the following steps are performed:
Select a box containing a focal issue to consider.
Select Box Pairs from the Create Menu. In response, a dialog box will appear showing a pair of issue boxes, with the selected issue box on the left and other issues appearing sequentially on the right of the dialog box.
Select manner in which to compare other boxes. Two choices are currently provided: comparing subsequent issues only (i.e., only those below and to the right on the Diagnostic Chart), or comparing all boxes. With either option, the user can then review and compare the boxes and determine which issues are related to each other.
Connect boxes. In the currently preferred embodiment, a user may select from three choices: an arrow originating in the first box, an arrow originating in the second box, or no arrow. After making a choice, a Next or Previous button can be selected to continue comparisons.
Select Done when all connections have been made.
After all other (or all subsequent) issue boxes have been examined relative to the selected issue (i.e., the box first selected), the focus issue in the left box automatically changes to the issue immediately below the selected issue on the Diagnostic Chart and the process continues. The user may change the order in which issues are examined by simply highlighting another issue box and selecting the “Box Pairs” option again to begin another analysis.

3. Arrow Chain Method: To connect a clear string of issues using the Arrow Chain Method involves the following steps:
Select Arrow Chain from the Create Menu. In response, an Arrow Chain Display Window appears below a Build Arrow Chain file with a blinking cursor. A user can then type the Code number of issue boxes in source box to destination box order, separated by space characters (e.g., 01, P3, P1, S2, 03) until all issues in that linear string have been entered. As entries are entered, the issue boxes being connected appear in a display window (Arrow Chain Display Window), making it easy for the user to check the accuracy of these connections.
After all the Arrow Chains have been entered, a user may click on the Build Chains button. In response, the arrows connecting all the issues in each of the linear strings of issues are drawn on screen in the Diagnostic Chart.

Users can also make use of this Arrow Chain feature at any time after linkages have been established by selecting an Arrow Chain option from the Create menu. This will bring up the Arrow Chain Entry tile, showing any linear strings of issues. A user may place the cursor in a chain on the entry file, and it will appear in a display window for editing or review.

In an alternative embodiment, users may also assign weights to connections between issues so as to indicate strength of the connection between issues. As described below, this alternative also includes features enabling users to remove (e.g., from a Theme or Linkage Chart as described below) connections and/or issue boxes having “weak” connections with each other. This enables users to focus on those issues that are more strongly connected to each other. The information removed from the display can easily be restored through use of a menu check box, if the user wishes to subsequently view all connections.

Viewing the Connections

FIG. 4C is a bitmap screenshot showing an example Diagnostic Chart 430 after issues have been input, categorized into Stream columns and connections between issues have been specified. As shown, issues are inside boxes and are categorized in one of four Stream columns (Organizing Arrangements, Social Factors, Technology and Physical Settings). Issues in the different Stream columns (categories) are distinguished through the use of different colors. Issues which are related to each other are shown interconnected by arrows. For example, both issue box 431 and issue box 435 are the source of causal connection arrows directed towards several other issue boxes. The example shown at FIG. 4C is a simple example used for purposes of illustration. However, it should be understood that a Diagnostic Chart would typically include a larger number of issues and numerous connections between issues, particularly in the case of larger organizations. For example, a Diagnostic Chart for a given organization may have 70 boxes representing issues with 300 arrows between various boxes on the Diagnostic Chart. Thus, in many cases very complex Charts are generated which makes it difficult for users to understand the relationships between issues and how the problems represented on the Diagnostic Chart may be addressed. To address these complexities, the present invention also includes several features which assist users in organizing and analyzing the issues presented in the Diagnostic Chart so as to enable the users to better understand the nature of the issues and the relationships among issues.

Sorting Issues

One feature of the present invention that can be used to organize the information is a sort function. After key interconnections between issues on the Diagnostic Chart have been defined, a sort function may be used to assist users in distinguishing core issues from symptoms. The sorting feature, when invoked, compares the number of incoming arrows to the number of outgoing arrows of issue boxes on the Diagnostic Chart. Boxes with a large number of incoming arrows and few (or no) outgoing arrows are generally considered as “symptoms” as they result from other issues, but do not themselves cause other issues. A perfect symptom might, for example, have seven incoming arrows and no outgoing arrows, indicting that the symptom is caused by these other issues and is not itself driving other issues. On the other hand, boxes with several outgoing arrows and few incoming arrows are considered as “core” issues as these issues are fundamental problems that are driving (causing) other issues in the organization. For example, a particular issue box having numerous outgoing arrows and no incoming arrows is typically considered to represent a core issue.

In an alternative embodiment in which connection arrows are weighted as “strong” or “weak” or using more fine weighting (e.g., strength weighted from 1 to 10 or strength represented as percentage), the sorting feature also examines the strength of the connections among issues. Issues that are strongly influencing (driving) other issues (e.g., as represented by strong connections to those other issues) may be viewed as “core” issues even if they have only a relatively small number of outgoing connection arrows.

FIG. 4D is a bitmap screenshot showing the example Diagnostic Chart of FIG. 4C after sorting. As shown, the Sort function rearranges the issues on the Diagnostic Chart so that core issues (i.e., issue boxes that are the source of several arrows coming out but with few (or none) coming in) appear toward the top of the Diagnostic Chart. For example, issue box 435 previously shown at FIG. 4C is now moved to the top of the Diagnostic Chart as shown at 435′ at FIG. 4D. Issue box 431′ at FIG. 4D remains in the same location (i.e., same location as issue box 431 at FIG. 4C) as it is a core issue with outgoing arrows directed towards several other issues. Symptomatic issues (i.e., issues with one or more arrows going into the box and few or none going out) are automatically placed toward the bottom of the Diagnostic Chart window. Issues with relatively equal numbers of incoming and outgoing arrows are referred to as linking issues. These linking issues are placed in the middle of the Diagnostic Chart between the core issues at the top and the symptoms at the bottom. Arrow connections between source boxes and destination boxes are maintained following the Sort procedure. A user can also use a submenu provided in the presently preferred embodiment which allows the user to renumber the issues if desired. The submenu gives the user the choice of maintaining the original box number or renumbering the issues to correspond to their new location on the Diagnostic Chart.

Boxes in the various Stream columns on the Diagnostic Chart can also be sorted manually by selecting a box and dragging it to the desired location on the Diagnostic Chart. For example, after an automatic Sort is performed, a user might decide that an issue really belongs in a category other than the one in which it was originally placed. To make this change, the user can drag and drop the box containing the issue into the desired position in the appropriate Stream column.

The sorting feature assists users in identifying core issues and symptoms; however, it does not reduce the overall complexity of a Diagnostic Chart. For example, a complex Diagnostic Chart for a large organization may have 70 issue boxes and 300 causal connection arrows as described above. Thus, users may still have difficulty understanding causal connections between issues represented on the Diagnostic Chart and making useful decisions regarding appropriate change actions to be taken to address such problems. Thus the present invention also includes additional features to assist users in navigating the complexity of the presented information and isolating the problems that appear to be good candidates for change action.

Linkages

In its presently preferred embodiment, the Stream Diagnostic module offers a “Linkage” features for clarifying interconnections between issues. A user can highlight a particular issue box such as issue box 431′ as shown at FIG. 4D then click on a “Linkages” button 436 (also shown at FIG. 4D) to quickly see how a single issue is linked to other issues on the Diagnostic Chart. If the particular issue selected is either a pure symptom (e.g., it only has arrows entering its box and none leaving) or a pure core problem (e.g., it only has arrows exiting its box), the system directly displays a Linkage Chart. However if the selected issue has arrows both entering and exiting it, a Dialog Box appears for the user to choose how to display the linkages.

In the presently preferred embodiment, the following display options are provided:
Choosing a first icon, with an arrow pointing into a box will isolate those issues causing the selected issue
Choosing a second icon, with an arrow pointing down from a box, v/ill isolate all issues being caused by the selected issue.
Choosing a third icon (the default mode) with arrows both entering and exiting the box will isolate all issues relating to the selected issue.

Based on the display option selected, the Linkage Chart shows only those issues linked to the selected issue, with the interconnected issues rearranged to show the direction of causality from cause to symptom. FIG. 4E is a bitmap screenshot illustrating a Linkage Chart window 440 of the Stream Diagnostic Module showing the selected issue of FIG. 431′ of FIG. 4D and those issues from the Diagnostic Chart that are connected, directly or indirectly, to this issue 431′. As also shown at FIG. 4E, the Linkage Chart window 440 includes a Diagnostic button 441, a Theme Summary button 442, a Discussion button 443, a Link Map button 444 and a Make Theme button 445 which may be utilized to perform certain functions. The Diagnostic button 441 returns the user to the Diagnostic Chart. The Discussion button 443 brings up supporting information (if any) relevant to a selected issue which is included in the Discussion List. The Make Theme, Theme Summary, and Link Map functions are discussed below in the discussion of how Theme Charts are created.

Creating a Theme Chart

Among the features of the Stream Diagnostic Module that users can utilize to better understand connections among issues are its “Theme” features. After the key interconnecting relationships on the Diagnostic Chart have been identified a Theme Chart can be created to show how issues are interrelated with one another. Theme features enable users to display subsets of the issues on the main Diagnostic Chart with the subset typically organized around a particular topic (i.e., a Theme). For example, there may be a problem with teamwork in an organization. A user or team could select all of the issue boxes that have direct or indirect connections to the issue box (or boxes) which specify teamwork problems in the organization. For instance, 12 out of a total of 70 issue boxes may relate to teamwork. This subset of 12 boxes can be organized and displayed separately from the Diagnostic Chart, enabling the user or team to focus on the teamwork problem and how it might be addressed. The ability to create Themes enables users or teams to begin to move from identification of individual issues to identification of clusters of related issues, thereby enabling related issues to be addressed more systematically.

Currently, two methods for Theme creation are provided in the currently preferred embodiment which are referred to as the “Building Block” and “Full Linkages” methods, respectively.

Building Block Method. The Building Block method allows one to construct a Theme Chart one issue at a time proceeding as follows:
Choose Theme Chart from the Create menu.
From the Theme Chart submenu, choose Select Object.
One may then decide which issues should be included in the Theme by tracing the connections (arrows) among them. A user can trace the source or destination of a given arrow by clicking on (selecting) the arrow. In response, the arrow will begin blinking making it easy to locate the box from which the arrow originates (and the box in which it terminates). As subsequent arrows are selected, previously traced arrows will remain selected, but they will stop blinking. Currently, only the latest arrow selected by the user will blink.
Include boxes in the Theme. A user can select (e.g., click on) an issue box on the Diagnostic Chart to include the box in the Theme being constructed.
After all selections have been made, the Theme may be created. A user may select “Create Theme Chart” from a Theme Chart submenu. In response, a dialog box will appear for the user to enter the name of the Theme. The dialog box also allows the user to choose to retain the Code box numbering that appears on the Diagnostic Chart or to renumber the boxed issues to reflect their position within the Theme sequence. A Theme may also be displayed in a constrained or unconstrained mode. When a Theme is displayed in constrained format, each of the issue boxes remains in its applicable Stream column. In other words, the manner in which the Theme is displayed is constrained by the topic area. On the other hand, if the user elects to have the Theme displayed in an unconstrained format, the issue boxes and their causal connections are displayed in a more simplified form. However, the boxes are displayed in different colors based on the Stream column (category) they were originally placed in so that the user can easily identify the Stream category to which an issue belongs. Rather than having boxes in various columns and traversing back and forth among them, boxes in different categories may be displayed in a more linear fashion, thereby making the causal relationships easier to follow and understand. Constrained and unconstrained Themes are further described below.

After the Theme name and formatting choices have been entered, a Theme Chart will appear. The Theme chart includes all of the boxes selected as part of the Theme. The causal relationship arrows which appeared between the boxes in the Diagnostic Chart will remain intact. However, arrows can be deleted and new arrows added in this mode, if desired.

Constrained Themes. Constrained Themes retain the basic Stream column format of the Diagnostic Chart although one can rename the Stream titles to better reflect the Theme subject if desired. Also, boxes can be repositioned so that the flow of arrows is downward, with symptom boxes lowest on the chart but remaining in their separate Streams. Arrows can be added or deleted to further fine-tune the Theme.

Unconstrained Themes. The same issues are presented as in a Constrained Theme, but are presented differently. The Title Bar (containing the Stream column headings) is missing, since the criteria for organizing the material is no longer the Stream category, but rather is now the linkages between the issues. (The Code numbers of the boxes still indicate the Stream category of each box). Also, since the issues are no longer “constrained” within Stream categories, the issue boxes can be repositioned both horizontally and vertically.

Full Linkages Method. Unlike the Building Block method, which composes a Theme one issue at a time the Full Linkages method starts out with an all-inclusive cluster of issues and then is decomposed in order to evolve into a true Theme. Creating a Theme Chart using the Full Linkage method proceeds as follows:
Designate an issue on the Diagnostic Chart
Activate the linkage method by either clicking on the Linkages button on the Header, or choosing Theme Chart from the Create menu, then selecting Form Linkages from the Theme Chart submenu. After the appropriate interconnection is selected from the dialog window, the Linkage Chart is displayed.
Clarify a Theme using Linkage Chart and/or Linkage Map. The Linkage Chart gives the user an opportunity to further clarify a Theme by removing issues not directly connected to a selected issue. The Linkage Map may also be used to assist in this process. The Linkage Map presents the same information as in the Linkage Chart, only in highly reduced form. Although the boxes contain no text in Linkage Map scale, highlighting a box brings up the box's text in an information bar. Boxes in the Linkage Map are placed in the same relative order as on the Linkage Chart, but without display of connecting arrows. The Linkage Map operates just as its name implies—even after issues are removed the “map” keeps a record of every issue box in the original Linkage Chart. This enables users to retrace their steps and reinstate any deleted issues if desired. Issue can be removed from a Theme using either the Linkage Chart screen or the Linkage Map screen. Any cuts made are reflected on both screens, with one variation. In the currently preferred embodiment, the boxes disappear from the Linkage Chart, but only switch to grayed boxes on the Linkage Map. In the currently preferred embodiment, a deleted box can only be reinstated through the Linkage Map. A user may highlight the grayed box on the Linkage Map and select an “Add” button to restore the selection (and all boxes connected it) to both the Linkage Map and the Linkage Chart.
After streamlining an issue cluster has been completed, the user may create a Theme based on the issues. For example, a user may select the Make Theme button 445 shown at FIG. 4E to create a Theme based on the issues displayed in the Linkage Chart Window 440. In response, the dialog window that was discussed earlier is displayed. FIG. 4F is a bitmap screenshot illustrating a Create Theme Chart dialog box 450. As shown, the dialog box 450 enables the user to enter the name of the Theme and to select either the constrained or unconstrained mode for display. After the Theme name and display option is selected, a Theme Chart is automatically displayed. This chart includes all of the boxes selected as part of the Theme.

FIG. 4G is a bitmap screenshot illustrating an example of an unconstrained Theme Chart 460. As shown, all of the issues are now displayed based on their relationship to the core issue at the top of the chart and they are not constrained in their original Stream columns. The causal relationship arrows, which appeared between the boxes in the Linkage Chart remain intact (although these arrows can be deleted and new arrows added in this mode). In the currently preferred embodiment, issue boxes included in a Theme are displayed on screen in a special order and using particular colors. For example, in the currently preferred embodiment all issues in the Organizing Arrangements Stream are displayed in blue, while those in the Social Factors category are red. Causal connection arrows are also color-coded based on the color of the box from which the arrow issues (i.e., the source box). As also shown at FIG. 4G, the issue boxes are arranged linearly with the first cause (core issue) at the top and the last symptom on the bottom. This graphically indicates to users that correcting the problem at the bottom requires addressing the other issues above it in the causal connection chain. The method for display of the Theme operates by finding longest chain of connections relating to currently selected issues. Generally, this longest chain is placed in the two middle columns of the Theme Chart as shown at FIG. 4G. If there are other alternative chains that are not the longest, those may also be displayed in columns 1 (on the left) and 4 (on the right) of the Theme Chart.

Comparing an unconstrained Theme to the original Diagnostic Chart shows that the Theme is much less cluttered with information and is generally easier to understand. For one thing, there are typically fewer issue boxes displayed. A Diagnostic Chart may, for example, have 70 issue boxes and 300 connections going back and forth among several columns (Stream categories) as previously described. With all of this information, it can be difficult to trace through issues from cause to symptom and to understand relationships among issues. In contrast, an unconstrained Theme typically has a smaller number of issues and can present the information in a more straightforward format. For example, a given Theme may have only eight issues (e.g., as shown at FIG. 4G) which are displayed in a fairly linear fashion that is easier for users to understand.

Hide Shortcuts Feature

Although the above features are very helpful in assisting users in distinguishing core problems from symptoms and in examining a subset of the issues in isolation, the information that is displayed can remain somewhat complex and difficult for some users to understand. Thus, it is desirable to provide additional features to enable users to reduce the complexity of the presented information. In particular, the numerous arrows among issues can make it difficult for a user to understand how issues are related, even if the user is only examining a smaller subset of issues on a Theme Chart. To address this issue, a “hide shortcuts” feature of the present invention enables information to be presented in simplified format, but without losing critical information.

The general operation of the hide shortcuts feature can be illustrated by example. Assume, for instance, that issue box A has a direct connection to box D. In addition, box A has a connection to box B, which in turn is connected to box C, which is connected to box D. Thus, in this case the direct connection or “shortcut” between box A and box D is duplicative as it is already connected indirectly through boxes B and C. The direct connection (shortcut) between boxes that are already connected indirectly is largely redundant (at least for many purposes). Accordingly, removing extraneous or duplicative information of this nature enables a more straightforward diagram of the relationship between issues to be presented to the user. The present invention provides a “hide shortcuts” option as shown at 465 at FIG. 4G which enables a user to elect to remove these shortcuts. When invoked, the hide shortcuts feature of the currently preferred embodiment automatically removes direct connection arrows between boxes that are already connected indirectly, so as to avoid display of extraneous information and provide for a simpler view of the relationships between issues. In an alternative embodiment, the strength, importance and other factors related to the link between boxes may determine the selection of particular arrows to hide when the hide shortcuts option is invoked.

In the presently preferred embodiment there is one exception made in that shortcuts are retained if they issue from the core or “first cause” problem (i.e., the core problem at top of Theme Chart). Whatever arrows are issuing from a core problem at the top of the Theme Chart are retained as this information about core issues is generally of highest importance to users. In most instances, it is very important to users to be able to easily identify all issues that relate to core problems as core problems are the start of chain and are generally viewed as originator of (or contributor to) all of the other problems in the chain.

FIG. 4H is a bitmap screenshot illustrating the same Theme Chart of FIG. 4G (now 460′) after the hide shortcuts feature has been invoked. In this specific example, there are only minor changes made as this particular Theme has a relatively small number of issue boxes and connection arrows. However, with more complex charts, the hide shortcuts feature typically removes a larger number of connection arrows, with the result that the Chart that is displayed has significantly fewer arrows and is less cluttered than the prior view. It should be noted that the connection arrows that are removed are not permanently lost and can be brought back (i.e., displayed again on screen), if desired.

Rather than a user manually removing arrows one by one by making judgments about each one, the present invention provides for removing arrows in a logical and automated fashion. It enables users to see more clearly the set of issues that are caused by the core problem (or problems) and, therefore, the improvements in organizational performance that can be realized if the core problem(s) is addressed. The simplified information about the core issue and its relationship to other issues can then be displayed to management, included in reports and the like, facilitating organizational alignment as to the problems that need to be addressed in order to realize performance improvements. It should be noted that the user can use a check box and menu item to restore the shortcuts that have been removed from the display if the user subsequently wishes to see additional information about all connected issues.

Shortcuts are generally identified during Theme creation. During creation of a Theme, two lists of arrows are created. The first list is a list of all arrows (including the “shortcut” arrows). The second list includes only the shortcut arrows (i.e., arrows to be hidden when the “hide shortcuts” feature is invoked).

In an alternative embodiment, arrows may be displayed based, at least in part, on weighting assigned to each connection arrow based on user input as to the strength of the connection. With this approach, when a user specifies connections between issue boxes on the Diagnostic Chart the user also specifies the strength of the connection. For example, the user may specify the strength of connection (e.g., from 1 (low) to 10 (high)). The user is then provided an option (e.g., on the Diagnostic Chart, the Linkages window and/or the Theme Chart window) to remove from the display connections and/or issue boxes with relatively low strength connections. For example, the user may elect to eliminate from a Linkage Chart or Theme all connections with connection strength of 3 and below. This serves to remove extraneous boxes and connections that may not be core to a given Theme (e.g., as indicated by low weights assigned to connection/link) enabling users to focus on the central issues which are more strongly related to each other.

Summary Chart

A Theme Summary button on the Theme Chart enables a user to bring up a chart that contains previously created Themes. (Access to the Theme Summary Chart is also available through a similar Theme Summary button on the Linkage Chart as previously described and shown at FIG. 4E). FIG. 4I is a bitmap screenshot showing a sample Theme Chart Summary 470. As shown, the Theme Summary Chart 470 provides access to two Themes (Leadership and Tech Knowledge in this example) which have been previously created and saved. It includes a Diagnostic button 471 which, when selected will cause the Diagnostic Chart to be displayed. It also includes a Discussion button 473 providing access to supporting material in the Discussion File as previously described. In addition, it includes a Theme button 472 which provides access to a Theme from the Theme Summary Chart (e.g., for display and/or editing). An entire Theme may also be deleted using the Summary Chart by highlighting the Theme and clicking the Delete button 475.

Making Changes to the Theme Chart

After a Theme Chart is created a user may wish to make changes. For example, a user may wish to delete or rearrange boxes or add arrows to the Theme Chart. A user may generally do so directly on the Theme chart. A user can also recreate a Theme with additional boxes by creating a new Theme which is based on the original Theme plus the additional boxed issues. To create the new Theme, the user will need to specify a different name than the original. However once it is created the original Theme can be deleted from the Theme Summary, and the name assigned to the revised Theme, if desired.

Balancing Comprehensiveness with Providing Useful Information

The Stream Diagnostic Module of the present invention enables users to create a very complex and comprehensive diagram of the problems affecting organizational performance. The solution also provides tools to assist users in generating useful information that they can use as the basis for action. Taking comprehensive information displayed in the picture in the Diagnostic Chart and through use of the features of the present invention for sorting, creation of Themes and removal of shortcuts, users can identify smaller sets of loosely coupled problems that may be good targets for change initiatives. Instead of one extremely complex picture including numerous problems, a user can use these features to create several smaller pictures with more clear relationships to each other that is more useful in identification of the specific issues that the organization may wish to address to improve organizational performance. Thus, the solution provides a balance between providing comprehensive information and providing information which is useful in identifying and resolving problems. Thus rather than generating tremendous volumes of information, the present invention provides features that assist users in identifying specific organizational problems that are impacting performance and how they relate to other problems the organization is experiencing.

### Detailed Operation

Creation of Theme from Linkage Chart

When the Stream Diagnostic software creates a Theme from a Linkage Chart, boxes are displayed in a well-defined arrangement determined by the lengths of chains of connected boxes. It should be noted that the following describes the currently preferred embodiment of the present invention which displays four stream columns, but those skilled in the art will appreciate that the same approach can be used with a different number of stream columns (e.g., ten streams instead of four). Generally, the longest chain of issue boxes connected to the linkage selected box will be displayed in the second stream column, the next longest chain in the third stream column, then the first column and then the fourth column. After these first four streams are placed in columns, the next longest chains of remaining boxes are placed in stream columns 2, 3, 1, and then 4, in order of decreasing length. Any remaining boxes are then added randomly at the bottom of the display screen. Each time the longest chain of remaining boxes is to be determined, a recursive, depth first, arbitrary directed graph traversal algorithm is performed to construct an ordered list.

Internal Data Structures

A CStreamDoc acts as a central dispatcher and repository for a particular document. It coordinates creation of new charts, keeps lists of existing charts, and coordinates communication between charts.

A CDiagObject is used to hold and manipulate the data on boxes and arrows used in a particular Theme, Linkage, or Diagnostic window. It has lists of all the boxes and arrows in a chart, and various properties used to determine how to display a chart. Application windows with boxes and arrows are drawn based on data in a CDiagObject. Other objects which control charts, such as CThemeMasters, give information about their boxes and arrows to other objects by passing a pointer to a CDiagObject.

CThemeMaster holds Theme data for all Themes in the document, and serves as a dispatcher for working with Themes. It has pointers to all Themes, the main document, and the CDiagObject of the current Theme window. It coordinates activities for dialogs to create new Themes or open existing ones, and to display them in a window. It also contains some members that are actually attributes of objects it interacts with, such as CThemeStores and CThemeWindows. Significantly, it also contains the functions which determine the positioning of boxes in the CThemeWindow based on the boxes in a CDiagObject.

CThemeStore contains the data necessary to display a Theme in a CThemeWindow: a unique name, used to search the CThemeMaster's list, a list of CLocalBoxes in the Theme, a list of CGlobalTextBox pairs which are connected by arrows, and flags to indicate whether this is a constrained or unconstrained Theme. CThemeMaster::ShowTheme uses a CThemeStore to create a CDiagObject, which is then displayed in a CDiagWindow.

CThemeWindow inherits from CDiagWindow, the basic re-sizable Streams window with buttons, scroll bars, header bar, and a view of boxes and arrows. The main difference from its base class is the buttons at the top, which are appropriate to the context of a Theme chart. It contains a CDiagView, which provides the basic functionality for drawing boxes and arrows in streams.

CLinkMaster is similar to CThemeMaster, but it deals with Linkage Charts rather than Theme charts. There is a CLinkWindow type, similar to CThemeWindow, with a button bar, m_pDiagBtnsWnd, whose member function CDiagBtns::OnMakeThemeBtn is the callback function executed when the “Make Theme” button is pressed while viewing a Linkage Chart. As described below, this is the start of events leading to creating of a Theme from a Linkage Chart.

The various arrow and text box types hold data about positioning, connections and the text in boxes. The types with “Global” in their name have attributes used in all charts when displaying every instance of a certain box or arrow, such as the box color and text. The types with “Local” in their name are used in a specific chart, and have attributes such as the column and row they are displayed in. “Global” and “Local” types have pointers to each other, with a 1 to n relationship.

CLocalBoxes are of particular interest, since they hold both the graphical properties of the column and row in which the box will be displayed, and lists of the arrows going to and from a particular box. This enables a box to get pointers to other boxes it is attached to, which facilitates adding recursive, depth first, arbitrary directed graph traversal functions to determine chain length. They also have a member function DrawBox, called by CDiagView, which draws the box in a window. The box itself contains the information on where it is positioned in the window.

Theme Creation

In the currently preferred embodiment of the present invention there are three ways for Themes to be created: from the list of previously defined Themes in the Theme summary dialog, from selected boxes in a Diagnostic Chart, or from a Linkage Chart. The following illustrates an example of creating a Theme from a Linkage Chart in the currently preferred embodiment of the present invention. By way of background, the following assumes that a Diagnostic Chart has previously been built as described above. Additionally, a particular issue box has been selected and a “linkage” button has been pressed to display a Linkage Chart. A user may then create a Theme from the Linkage Chart as described in the following example.

The Theme creation routine is invoked through a call to CStreamDoc::MakeThemeBtn( ) when a user presses a “Make Theme” button from the Linkage Chart as illustrated by the following:

```
void CStreamDoc::MakeThemeBtn ( )
1:
  2: //Called from linkage window's DiagBtn window when user presses
  3: //Make theme chart from linkage chart button
  4: {
  5: m_pLinkMaster->MakeTheme ( );
  6: }
```

As shown at line 5 above, when invoked CstreamDoc::MakeThemeBtn( ) calls CLinkMaster::MakeTheme which is illustrated below:

```
1: void CLinkMaster::MakeTheme ( )
  2:
  3: //Makes a theme chart from current Linkage chart. Currently, since
  4: //ThemeMaster is set up to work from diag chart selected objects, we
  5: //select all the objects in the link diag object and pass that to
  6: //theme master.
  7: {
```

| | |
|---|---|
| 8: POSITION | pos; |
| 9: CLocalBox* | pLBox; |
| 10: int | col, count; |

11:
12: m_pLinkObj->ClearSelectedList ( );
13: count = 0;
14: for (col = 0; col < MAXCOLS; col++)
15: {
16: for (pos = m_pLinkObj->GetFirstBox (col); pos != 0;)
17: {
18: pLBox = m_pLinkObj->GetNextBox (col, pos);
19: m_pLinkObj->SelectMyBox (pLBox);
20: pLBox->SetSelected (TRUE);
21: count ++;
22: }
23: }
24:
25: if (!count) //no boxes in linkage list, can't make theme chart
26: return;
27:
28: m_pDoc->CreateThemeFromLink (m_pLinkObj);
29:
30: m_pLinkObj->ClearSelectedList ( );
31: for (col = 0; col < MAXCOLS; col++)
32: {
33: for (pos = m_pLinkObj->GetFirstBox (col); pos != 0;)
34: {
35: pLBox = m_pLinkObj->GetNextBox (col, pos);
36: pLBox->SetSelected (FALSE);
37: }
38: }
39: }

The above routine performs a number of initialization steps. As shown above at line 12, a ClearSelectedList( ) function is called to make sure all nodes are clear. Next, all boxes in the Linkage Chart are identified by looping over columns and rows of the Linkage Chart. As shown, the call to GetFirstBox inside the for loop at line 16 calls an MFC routine to find the head position of the list, while the call to GetNextBox at line 18 finds the next position of the list. The call to SelectMyBox shown at line 19 adds the local text box to a list of selected boxes. The SelectMyBox method of CDiagObject is as follows:

```
1: void CDiagObject::SelectMyBox (CLocalBox* pLBox)
  2:
  3: //Add the passed local text box to list of selected boxes
  4: {
  5:  TRACE(“CDiagObject::SelectMyBox adding box at (%i, %i)\n”,
pLBox->GetBoxCol( ), pLBox->GetBoxRow( ));
  6:
  7: //AddTail is a MS routine to add the Tail to the given object
  8:  m_SelectedBoxes.AddTail (pLBox);
  9:  TRACE(“this: %x CDiagObject::SelectMyBox now %i boxes in
list\n”, this, m_SelectedBoxes.GetCount( ));
10: }
```

After the above SelectMyBox method is invoked, SetSelected is set to true as shown at line 20 in the above CLinkMaster::MakeTheme routine. As provided at line 28 of the above CLinkMaster::MakeTheme routine, CStreamDoc::CreateThemeFromLink is invoked.

The CStreamDoc::CreateThemeFromLink function, in turn, passes the call to the following CreateTheme function of CThemeMaster:

```
  1: BOOL CThemeMaster::CreateTheme (CDiagObject* pDiagObj)
  2:
  3: //Called from Doc's menu handler when user chooses Create | Create
theme
  4: //Prompt for theme name and constrained/unconstrained, then do it
  5: {
```

| | |
|---|---|
| 6: CThemeNameDlg* | pThemeNameDlg; |
| 7: THEMENAMESTUFF | tm; |

```
  8:  CThemeStore* pThStore;
  9:  WORD iChartType = pDiagObj->GetChartType( );
10:
```

| 11: CWinApp* | pApp = AfxGetApp ( ); | |
|---|---|---|
| 12: HCURSOR | hourCursor | = pApp->LoadStandardCursor (IDC_WAIT); |
| 13: HCURSOR | arrowCursor | = pApp->LoadStandardCursor (IDC_ARROW); |

14:
15: //First do some validation stuff
16: if (m_ThemeStoreList.GetCount ( ) >= MAX_THEMESUMS)
17: {
18: AfxMessageBox (“Sorry, you've already created the maximum
allowable number of theme charts.”);
19: return FALSE;
20: }
21:
22: switch(iChartType)
23: {
24: case DIAG_CHART:
25: if (!PrepSelectedList (pDiagObj)) //make our copy of selected
boxes
26: return FALSE; //FALSE = there are none
27: break;
28: case LINK_CHART:
29: CopyLinkBoxes( );
30: break;
31: }
32:
33: //Then put up the dlg for user to name and specify the kind of
theme chart
34: pThemeNameDlg = new CThemeNameDlg (this, &tm);
35: pThemeNameDlg->DoModal ( );
36: delete pThemeNameDlg;
37: if (tm.bCancel)
38: return FALSE;
39:
40: //Finally create new theme object, init & call routines to build it
41: pThStore = new CThemeStore (&tm);
42: m_ThemeStoreList.AddTail (pThStore);
43: m_pCurThStore = pThStore;
44:
45: ::SetCursor (hourCursor);
46: for (int i = 0; i < MAXCOLS; i++)
47: m_iCurRow [i] = 0; //init starting theme chart row for each col
48: if (tm.bConstrained)
49: BuildConstrained (pThStore, tm.bOrigNumbers);
50: else
51: BuildUnconstrained (pThStore, pDiagObj);
52:
53: // for themes from linkage charts, only use the arrows shown on the
linkage chart,
54: // throw out the list of arrows based on the diag chart and global
arrows
55: if (iChartType == LINK_CHART)
56: pThStore->LoadLinkArrows(m_pDoc->GetLinkMaster( ));
57:
58: ShowTheme (tm.cName); //and of course build theme window & display
it
59:
60: ::SerCursor (arrowCursor);
61:
62: return TRUE;
63: }

As provided at line 9, a determination is first made as to what kind of Chart (i.e., Diagnostic: 1; Theme: 2; Linkage 3: etc.) is involved. In this example where a Theme is created from a Linkage Chart, a Linkage Chart would be identified. As shown at lines 16-20, a check is also made to make sure the maximum allowed number of Themes is not exceeded. Commencing at line 22, a switch statement provides for different steps to be taken based on the type of chart that is involved. In this case, the Theme is being created from a Linkage Chart, so a CopyLinkBoxes( ) function is called as shown at line 29. The CopyLinkBoxes( ) function uses MFC routines to copy linked boxes.

After the linked boxes are copied, a graphic window is opened to ask the user to supply the name for the Theme being created as shown above at lines 34-38. As previously described, the user is also provided options to build a constrained or an unconstrained Theme. When the user supplies the name, the Theme creation process continues. At this point a new, empty CThemeStore object is created based on the information returned by the Theme name dialog. Depending on whether the user has selected to build a constrained or unconstrained Theme, the routines to build the Theme are called as shown at lines 46-51 of the above CThemeMaster::CreateTheme function. The CThemeMaster::BuildUnconstrained function for building an unconstrained Theme is included below. It should be noted that for a Theme created from a Linkage Chart, only the arrows shown on the Linkage Chart are used in building the Theme.

Finally, CThemeMaster::ShowTheme is called as shown at line 58 of the above CThemeMaster::CreateTheme function in order to build the Theme window and display the Theme in the user interface. The process for building the Theme window and displaying it is described below in more detail. Before describing the CThemeMaster::ShowTheme function for displaying the Theme, the following is the CThemeMaster::BuildUnconstrained function that is invoked if the user has specified an Unconstrained Theme is to be built:

```
1: void CThemeMaster::BuildUnconstrained (CThemeStore* pThStore,
CDiagObject *pDiagObj)
  2:
  3: //Build unconstrained chart from currently selected diag chart
  4: //boxes.
  5: {
  6:  if(pDiagObj->GetChartType( ) == LINK_CHART)
  7:  AddLinkBoxes(*pThStore);
  8:
  9:  AddLongestChains(*pThStore);
10:  AddAllBoxes(*pThStore);
11:
12: } // end BuildUnconstrained
```

As shown at lines 6-7, an AddLinkBoxes function is invoked only for a Theme created from a Linkage Chart (LINK_CHART). The AddLinkBoxes function finds the selected or “base” box and identifies the longest chains of boxes with arrows going into and/or out of the selected box. As described previously, the length of incoming and outgoing chains impacts how they will be displayed (e.g., in which of the stream columns they will be displayed).

In the presently preferred embodiment, there are two routines which provide for displaying a Theme that has been created, namely ShowTheme and DisplayTheme. The reason for having two different functions is to separate out the scale handling which is different for Theme chart creation and display in that it tracks Diagnostic Chart scale. The ShowTheme function is called at the end of the process of creating a new Theme chart in order to display the new Theme chart. The function is also called when a user has selected a previously created Theme to display from the Theme summary dialog. The function creates a Theme window (if it doesn't already exist), expands the Theme object whose name is passed into a Theme window object and displays the Theme (e.g., in the user interface). The ShowTheme function is as follows:

```
  1: void CThemeMaster::ShowTheme (CString cName)
  2: {
  3:  int curThemeScale;
  4:
  5:  DisplayTheme(cName);
  6:
  7:  // scale handling: set same as diagnostic chart
  8:
  9:  curThemeScale = m_pDoc->GetCurWindowScale(TRUE);
10:  m_pDoc->SetCurThemeScale(curThemeScale); // re-set/refresh
theme chart scale
11:
12: }
```

As shown above at line 5, the ShowTheme function calls the following DisplayTheme function which is a core routine for displaying a Theme in a user interface window. The call to SetCurThemeScale illustrated at line 10 sets the scale consistent with Diag display scale.

The DisplayTheme function of CThemeMaster is as follows:

```
  1: void CThemeMaster::DisplayTheme (CString cName)
  2: {
```

| | |
|---|---|
| 3: CStreamspApp* | pApp = (CStreamspApp*) AfxGetApp ( ); |
| 4: CMultiDocTemplate* | pThemeDocTemplate = pApp->GetThemeDocTemplate( ); |
| 5: CThemeStore* | pThStore; |
| 6: CString | caption; |
| 7: CDiagObject | *pDiagObj = m_pDoc->GetDiagObject(DIAG_CHART); |

```
  8:
  9:  //Need to destory & make a new one because if we are flipping
10:  //between constrained/unconstrained, 1 has no hdrs, the other does
11:  if (m_pThemeWnd)
12:  m_pThemeWnd->DestroyWindow ( );
13:
14:  pThStore = FindTheme (cName);
15:  if (pThStore == 0)
16:  {
17:  TRACE (“CThemeMaster::ShowTheme can't find theme %s\n”, cName);
18:  return;
19:  }
20:  m_pCurThStore = pThStore; //save it in case user cuts boxes
21:
22:  m_bConstrained = pThStore->m_bConstrained; //so we can pass it to
theme wnd
23:  MakeThemeChartObj (pThStore);
24:
25:  m_pThemeWnd = (CThemeWindow*) pThemeDocTemplate->CreateNewFrame
(m_pDoc, NULL);
26:  pThemeDocTemplate->InitialUpdateFrame (m_pThemeWnd, m_pDoc);
27:
28:  //m_pDiagSetWindowText(cr_DiagCaption);
29:  caption = “Theme Chart: ” + cName + “ for ”;
30:  caption += cr_DiagCaption;
31:  m_pThemeWnd->SetCaption (caption);
32:
33:  // For the correct text to appear in the menu
34:  m_pThemeObj->m_bShowShortcuts = pThStore->AreshortcutsShown( );
35:
36: }
```

Of particular significance, the above DisplayTheme routine calls MakeThemeChartObj as provided at line 23. This MakeThemeChartObj routine, among other things, calls the functions which are described below in order to identify shortcuts in the Theme and provide for their display.

Showing and Hiding Shortcuts

The following describes the process for showing and hiding shortcuts for a Theme created from a Linkage Chart in the currently preferred embodiment of the present invention. It should be noted that some different routines are called in the case of Themes made from a Diagnostic Chart.

As previously described, the above CThemeMaster::DisplayTheme routine calls CThemeMaster::MakeThemeChartObj which is illustrated below:

```
1: void CThemeMaster::MakeThemeChartObj (CThemeStore* pThStore)
  2:
  3: //Make a CDiagObject to use for the theme chart from the
  4: //passed CThemeStore. The theme is displayed in a CDiagView
  5: //object, which will use this “theme” CDiagObject.
  6: {
```

| | |
|---|---|
| 7: POSITION | pos; |
| 8: CLocalBox* | pLBox; |
| 9: CGlobalTextBox* | pGBox, *pFromGBox=NULL, *pToGBox=NULL; |
| 10: CLocalBox* | FromBox, *ToBox; |

11: CDiagObject *pDiagObj = m_pDoc->GetDiagObject(DIAG_CHART);
12: CDiagHdr* pDHdr = pDiagObj->GetpDHdr ( ); //if we don't create one
for the theme view, need it from diag chart's diag obj
13:
14: if (m_pThemeObj)
15: delete m_pThemeObj; //if we have an old one hanging around,
delete it
16: m_pThemeObj = new CDiagObject (m_pDoc, pDHdr, THEME_CHART);
17: m_pDoc->SetThemeObject (m_pThemeObj); //view gets its diag obj from
doc
18: TRACE(“CThemeMaster::MakeThemeChartObj created its CDiagObject at
%x\n”, m_pThemeObj);
19:
20: //get the local boxes that belong to this theme
21: for (pos = pThStore->GetFirstBoxPos ( ); pos != 0;)
22: {
23: pLBox = pThStore->GetNextBox (pos);
24:
25: //If this theme was displayed earlier, some boxes may have been
26: //selected when the chart was destroyed. Don't leave them
selected now.
27: pLBox->SetSelected (FALSE);
28: m_pThemeObj->AddLocalBox (pLBox->GetBoxCol( ), pLBox);
29:
30: //When a theme's local box is created from the corresponding
31: //diag chart lbox, it is given the diag chart's global box.
32: //Thus the glo box can be associated with a diag chart local
33: //box and with many theme chart local boxes. But only one
34: //theme chart is active at a time. Hence now we must tell the
35: //glo box which (of its possibly many) local theme box is active
36: pGBox = pLBox->GetGlobalBox ( );
37: pGBox->SetThemeLocalBox (pLBox); //connect global box to this
theme chart local box
38: }
39:
40: //Now build arrows connecting them. The boxes put in the theme
41: //store's m_ArrowBoxes list are the global boxes, from which we get
42: //the theme chart local boxes connected by each arrow
43: for (pos = pThStore->GetFirstArrowPos ( ); pos != 0;)
44: {
45: pThStore->GetNextArrowPair(pos, pFromGBox, pToGBox);
46: FromBox = pFromGBox->GetThemeLocalBox ( );
47: ToBox = pToGBox->GetThemeLocalBox ( );
48:
49: m_pThemeObj->RouteConnection (NULL, TRUE, FALSE, FALSE,
50: FromBox, ToBox);
51: }
52:
53: /* Identify shortcuts if it hasn't been done before.
54: Existence of arrows in shortcuts list used as a check
55: for whether this has been done before. */
56: if(pThStore->GetShortcutListStart( ) == NULL) // If the list is empty
57: {
58: IdentifyShortcuts( );
59: }
60:
61: }

The above function gets all the local boxes that belong to a given Theme as illustrated above at lines 21-23. The arrows connecting the boxes are then built as provided at lines 43-51. MakeThemeChartObj then calls an IdentifyShortcuts function which marks (i.e., identifies) shortcuts (including loops) for a diagram object (CDiagObject).

The IdentifyShortcuts function is illustrated below:

```
1: void CThemeMaster::IdentifyShortcuts( )
  2: {
  3:
  4:  CLocalBox *pLBox;
  5:  POSITION pos;
  6:
  7:  TRACE(“CThemeMaster::HideShortcuts marking shortcut arrows
for diagObj %x\n”, m_pThemeObj);
  8:
  9:  // loops aren't technically “shortcuts”, but we include them in
this feature.
10:  // hide them first, or else shortcuts will be hidden that depend on
11:  // a looping arrow for the longer path.
12:  for (pos = m_pCurThStore->GetFirstBoxPos ( ); pos != 0;)
13:
14:  {
15:  pLBox = m_pCurThStore->GetNextBox (pos);
16:  pLBox->MarkLoops(m_pCurThStore);
17:  }
18:
19:  for (pos = m_pCurThStore->GetFirstBoxPos ( ); pos != 0;)
20:
21:  {
22:  pLBox = m_pCurThStore->GetNextBox (pos);
23:  pLBox->MarkShortcutArrows(m_pCurThStore);
24:  }
25:
26: }
```

A call to the MarkLoops function shown above at line 16 identifies the loops and cuts them for the purpose of finding longest chain to the end box. Subsequently, MarkShortcutArrows is called to identify and marks arrows that provide a shortcut where a longer path from one box to the next exists. The MarkLoops and MarkShortcutArrows functions are illustrated below.

The following MarkLoops function simply calls CutLoops as shown below:

1: void CLocalBox::MarkLoops(CThemeStore *pTheme)
2: {
3: CutLoops(this, pTheme);
4: }

The CutLoops function which is invoked is as follows:

```
  1: void CLocalBox::CutLoops(CLocalBox *pStartBox, CThemeStore* pTheme)
  2: {
```

| | |
|---|---|
| 3: POSITION | pos; |
| 4: CLocalArrowPoint* | pArrPt = NULL; |
| 5: CLocalBox* | pNextLBox = NULL; |

```
  6:  CLocalArrow* pArrow;
  7:
  8:  if(m_bInGraph)
  9:  return;
10:
11:  m_bInGraph = true; // don't loop infinitely if graph cycles
12:
13:  for (pos = m_arrowsOut.GetHeadPosition( );
14:  pos != NULL;
15:  )
16:  {
17:  // get a pointer to the box at the other end of the next arrow
18:  pArrPt = m_arrowsOut.GetNext(pos);
19:  pArrow = pArrPt->GetArrow( );
20:  pNextLBox = pArrPt->GetEndBox ( );
21:
22:  if(pArrow->m_bIsShortcut == true)
23:  {
24:  /*TRACE(“ (%d, %d) -> (%d, %d) is already marked as a shortcut,
skipping in CutLoops.\n”,
25:  m_col, m_row, pNextLBox->m_col, pNextLBox->m_row);*/
26:  continue;
27:  }
28:
29:  // Does the arrow go back to a box with a path to us which is
farther up?
30:  if((pNextLBox == pStartBox) && (pStartBox->m_row < this->m_row))
31:  {
32:  // Leave arrows that comprise the longest chain.
33:  if(pStartBox->m_iLongestChainPlace == m_iLongestChainPlace+1)
34:  {
35:  TRACE(“ (%d, %d) -> (%d, %d) ”, m_col, m_row,
pNextLBox->m_col, pNextLBox->m_row);
36:  TRACE(“is part of the longest chain, skipping in
CutLoops.\n”);
37:  continue;
38:  }
39:
40:  // a loop was found, this arrow is the end of it
41:  TRACE(“(%d, %d) -> (%d, %d), Marking Arrow %x as a loop.\n”,
42:  m_col, m_row, pNextLBox->m_col, pNextLBox->m_row, pArrow);
43:  pTheme->MarkAsShortcut(GetGlobalBox ( ), pNextLBox->GetGlobalBox ( ));
44:  pArrow->m_bIsShortcut = true;
45:  }
46:  else
47:  {
48:  /* TRACE(“, (%d, %d) -> (%d, %d)”,
49:  m_col, m_row, pNextLBox->m_col, pNextLBox->m_row);*/
50:  pNextLBox->CutLoops(pStartBox, pTheme);
51:  }
52:  }
53:
54:  m_bInGraph = false;
55: }
```

The above routine recursively looks for the longest chain to a given end box by calling MarkAsShortcut and IsLongerChain to identify shortcuts. The call to MarkAsShortcut is shown above at line 43. It should be noted that shortcut arrows out of the end boxes always remain unhidden in the Theme because of the association of the end box with core issues.

The operations of the below MarkAsShortcut function are specific to Theme charts. Before this function is called, the CThemeStore has its list of connected boxes, and the CLocalArrows that comprise those connections have all been created and routed. The following MarkShortcutArrows routine identifies and marks arrows that provide a shortcut where a longer path from one box to the next exists, or paths that loop back from a box further down the chain:

```
  1: void CLocalBox::MarkShortcutArrows(CThemeStore* pTheme)
  2: {
  3:  POSITION posToTest, posAltRt;
  4:  CLocalArrowPoint* pArrPtToTest, *pAltRouteArrPt;
```

| | |
|---|---|
| 5: CLocalArrow* | pArrow; |
| 6: CLocalBox* | pNextLBox = NULL; |
| 7: CLocalBox* | pEndLBox = NULL; |

```
  8:
  9:  if ((m_row == 1)&&(m_col == (int) (MAXCOLS−1)/2)) //skip
    the top row
10:  return;
11:
12:  m_bInGraph = true; // don't loop infinitely if graph cycles
13:
14:  // Loop through all outgoing arrows
15:  for (posToTest = m_arrowsOut.GetTailPosition( );
16:  posToTest != NULL;
17:  )
18:  {
19:  // select one arrow, get the box at the other end
20:  pArrPtToTest = m_arrowsOut.GetPrev(posToTest);
21:  pEndLBox = pArrPtToTest->GetEndBox ( );
22:
23:  TRACE(“Arrow from (%d, %d) to (%d, %d) ”, m_col, m_row,
pEndLBox->m_col, pEndLBox->m_row);
24:  pArrow = pArrPtToTest->GetArrow( );
25:  if(pArrow->m_bIsShortcut == true)
26:  {
27:  TRACE(“ is already marked as a shortcut, skipping in Mark
Shortcut Arrows.\n”);
28:  continue;
29:  }
30:
31:  // Leave arrows that comprise the longest chain.
32:  if(pEndLBox->m_iLongestChainPlace ==
      m_iLongestChainPlace+1)
33:  {
34:  TRACE(“is part of the longest chain, skipping in Mark
Shortcut Arrows.\n”);
35:  continue;
36:  }
37:
38:  // loop through all other arrows, look for alternate routes
39:  for (posAltRt = m_arrowsOut.GetHeadPosition( );
40:  posAltRt != NULL;
41:  )
42:  {
43:  pAltRouteArrPt = m_arrowsOut.GetNext(posAltRt);
44:  pArrow = pAltRouteArrPt->GetArrow( );
45:  if(pArrow->m_bIsShortcut == true)
46:  {
47:  //TRACE(“ is already marked as a shortcut, skipping in
Mark Shortcut Arrows inner loop.\n”);
48:  continue;
49:  }
50:
51:  pNextLBox = pAltRouteArrPt->GetEndBox ( );
52:
53:  // Skip the direct arrow to the end box, it's always the
shortest path.
54:  if(pNextLBox == pEndLBox)
55:  continue;
56:
57:  if (pNextLBox->IsLongerChain(pEndLBox))
58:  {
59:  // an alternate, longer route was found
60:  pArrow = pArrPtToTest->GetArrow( );
61:  TRACE(“Marking Arrow %x as a shortcut.\n”, pArrow);
62:  pArrow->m_bIsShortcut = true;
63:  pTheme->MarkAsShortcut(GetGlobalBox ( ),
pEndLBox->GetGlobalBox ( ));
64:  break;
65:  }
66:  }
67:  }
68:  m_bInGraph = false;
69:  return;
70: }
```

Of particular interest above, a call to IsLongerChain as shown above at line 57 provides for a recursive search for a longer path to a given end box (pEndBox).

The IsLongerChain routine which is invoked is illustrated below:

```
  1: bool CLocalBox::IsLongerChain(CLocalBox *pEndBox)
  2: {
  3:
```

| | |
|---|---|
| 4: POSITION | pos; |
| 5: CLocalArrowPoint* | pArrPt = NULL; |
| 6: CLocalBox* | pNextLBox = NULL; |

```
  7:  CLocalArrow* pArrow;
  8:
  9:  if(m_bInGraph)
10:  return false;
11:
12:  m_bInGraph = true; // don't loop infinitely if graph cycles
13:
14:  for (pos = m_arrowsOut.GetHeadPosition( );
15:  pos != NULL;
16:  )
17:  {
18:  pArrPt = m_arrowsOut.GetNext(pos);
19:  pArrow = pArrPt->GetArrow( );
20:  pNextLBox = pArrPt->GetEndBox ( );
21:  if(pArrow->m_bIsShortcut == true)
22:  {
23:  /* TRACE(“ (%d, %d) -> (%d, %d) is already marked as a
shortcut, skipping in IsLongerChain.\n”,
24:  m_col, m_row, pNextLBox->m_col,
          pNextLBox->m_row);*/
25:  continue;
26:  }
27:  /* TRACE(“, (%d, %d) -> (%d, %d)”,
28:  m_col, m_row, pNextLBox->m_col, pNextLBox->
      m_row);*/
29:
30:  // recurse until we get to the end box or run out of arrows
31:  if((pNextLBox == pEndBox) ||pNextLBox->
      IsLongerChain(pEndBox))
32:  {
33:  if(pNextLBox == pEndBox)
34:  TRACE(“(%d, %d) -> (%d, %d), Longer chain found.\n”,
35:  m_col, m_row, pNextLBox->m_col,
          pNextLBox->m_row);
36:
37:  m_bInGraph = false;
38:  return true;
39:  }
40:  }
41:
42:  m_bInGraph = false;
43:  return false;
44: }
```

The above function searches for a longer path to a given end box. As shown, the function recurses until all arrows are enumerated or the end box is reached.

The MarkAsShortcut function is as follows:

```
1: void CThemeStore::MarkAsShortcut(CGlobalTextBox *pSrcGBox,
CGlobalTextBox *pDestGBox)
  2: {
  3:  POSITION pos;
  4:  CGBoxPair* pBoxes;
  5:  bool bAlreadyMarked = false;
  6:
  7: /* for (pos = m_ShortcutArrows.GetHeadPosition ( ); pos != 0;)
  8:  {
  9:  pBoxes = m_ShortcutArrows.GetNext (pos);
10:  if ((pSrcGBox == pBoxes->from) && (pDestGBox ==
      pBoxes->to))
11:  {
12:  bAlreadyMarked = true;
13:  }
14:  if ((pSrcGBox == pBoxes->to) && (pDestGBox ==
      pBoxes->from))
15:  {
16:  bAlreadyMarked = true;
17:  }
18:  }//*/
19:
20:  if(!bAlreadyMarked)
21:  {
22:  pBoxes = new CGBoxPair( );
23:  pBoxes->from = pSrcGBox;
24:  pBoxes->to = pDestGBox;
25:  m_ShortcutArrows.AddTail (pBoxes);
26:  }
27: }
```

Shortcuts are identified during Theme creation. The Theme store has two lists of arrows, one of all arrows and one of shortcut arrows (or shortcuts). The above functions are called when Themes are built to identify shortcut arrows. Shortcuts that are identified are added to a list of shortcut arrows. The list of all arrows (including shortcuts) is maintained separately and is not impacted by the process of identifying shortcut arrows. As noted in the prior discussion, the list of shortcut arrows is maintained so that it can be hidden when desired, such as in response to a user selecting a “hide shortcuts” feature in user interface.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

1. A method for assisting a user in diagnosing solutions to issues affecting performance of an organization, the method comprising:
receiving a list of issues which affect performance of an organization;
in response to user input selecting a predefined category for each issue on said list, generating a diagnostic chart including each issue in a column corresponding to the selected category;
creating arrows connecting issues on the diagnostic chart based on user input specifying causal connections between issues;
in response to user selection of a particular issue on the diagnostic chart, displaying a theme chart including all issues from the diagnostic chart connected to the particular issue;
identifying a direct connection arrow between a first issue and second issue on the theme chart which are already connected indirectly through one or more other issues; and
automatically removing from display said direct connection arrow, so as to clarify information displayed to the user.

2. A computer-readable medium having processor-executable instructions for performing the method of claim 1.

3. The method of claim 1, further comprising:
downloading a set of processor-executable instructions for performing the method of claim 1.

4. A method for identifying issues affecting performance of an organization, the method comprising:
receiving user input of a plurality of issues affecting performance of an organization;
in response to user input categorizing each of said plurality of issues, creating a chart including each issue displayed in a column based on its categorization;
generating arrows connecting issues on the chart based on user input specifying causal connections between issues;
in response to user selection of a particular issue displayed on the chart, displaying a subset of the chart including all issues connected directly and indirectly to the particular issue; and
automatically removing a connecting arrow directly between a first issue and second issue on the chart subset when the first issue and second issue are already connected indirectly through one or more other issues, so as to clarify information displayed to the user.

5. The method of claim 4, wherein said step of creating a chart includes displaying the chart in a user interface of a computer system.

6. The method of claim 4, wherein said step of creating a chart includes specifying at least four categories for categorization of issues and displaying issues in columns corresponding to said at least four categories.

7. The method of claim 5, wherein said step of creating a chart includes displaying each issue in a box in the column corresponding to the user specified categorization of the issue.

8. The method of claim 7, wherein said step of generating arrows includes generating a connecting arrow directed from a first box towards a second box on the chart based on user input specifying that the issue in the first box is causing the issue in the second box.

9. The method of claim 8, further comprising:
automatically sorting issue boxes displayed on the chart based on incoming and outgoing arrows connected to each issue box, wherein issue boxes having more outgoing arrows than incoming arrows are placed towards the chart top and issue boxes having more incoming arrows are placed towards the chart bottom, so as to display issues which are causing other issues at the top of the chart.

10. The method of claim 4, wherein said step of generating arrows includes receiving user input specifying causal connection strength between issues on the chaff.

11. The method of claim 10, further comprising:
automatically sorting issue boxes displayed on the chart based, at least in part, on said causal connection strength.

12. The method of claim 4, wherein said step of generating arrows includes receiving user input specifying importance of issues on the chart.

13. The method of claim 10, further comprising:
automatically sorting issue boxes displayed on the chart based, at least in part, on said importance of issues.

14. The method of claim 4, wherein said step of displaying a subset of the chart includes identifying all incoming and outgoing arrows directly connected to the particular issue and displaying all issues associated with said incoming and outgoing arrows.

15. The method of claim 14, wherein said step of displaying a subset includes displaying the issues in chains, wherein the chains are based on causal connections among issues.

16. The method of claim 15, wherein said step of displaying a subset includes displaying an issue with only outgoing arrows at the chart top, so as to indicate the issue is causing other issues.

17. The method of claim 15, wherein said step of displaying a subset includes displaying an issue with only incoming arrows at the chart bottom, so as to indicate the issue is symptom caused by other issues.

18. The method of claim 4, wherein said step of automatically removing a connecting arrow operates in response to user invocation of a feature for automatically removing such connecting arrows.

19. The method of claim 18, further comprising:
restoring the connecting arrow in response to user input for undoing removal of such connecting arrows.

20. The method of claim 4, further comprising:
a computer-readable medium having processor-executable instructions for performing the method of claim 4.

21. A system for diagnosing issues affecting organizational performance, the system comprising:
a computer having a processor and memory;
a user input module for receiving user input of a plurality issues affecting organizational performance of an organization, categorizing each of said plurality of issues and specifying causal connections among issues;
a diagnostic module that generates a chart displaying the plurality of issues in columns, with each issue placed in a column corresponding to its categorization for display, and displaying arrows connecting issues on the chart based on specified causal connections between issues;
a linkage module which displays a subset of the chart including all issues linked directly and indirectly to the particular issue in response to user selection of a particular issue displayed on the chart; and
a shortcuts module that, when invoked, automatically removes a connecting arrow directly between a first issue and second issue on the chart subset when the first issue and second issue are already linked indirectly through one or more other issues, so as to clarify information displayed to the user.

22. The system of claim 21, wherein said diagnostic module displays the chart in a user interface of the computer system.

23. The system of claim 22, wherein said diagnostic module displays issues in at least four columns, with issues placed in a given column based on their categorization.

24. The system of claim 21, wherein said diagnostic module displays each issue in a box in a column based on the categorization of the issue.

25. The system of claim 24, wherein said module for generating displays a connecting arrow directed from a first box towards a second box on the chart based on user input specifying that the issue in the first box is causing the issue in the second box.

26. The system of claim 25, further comprising:
a sort module for automatically sorting issue boxes displayed on the chart based on incoming and outgoing arrows connected to each issue box.

27. The system of claim 26, wherein said sort module places issue boxes having more outgoing arrows than incoming arrows towards the chart top and places issue boxes having more incoming arrows towards the chart bottom, so as to display issues which are causing other issues at the top of the chart.

28. The system of claim 21, wherein said user input module receives user input specifying causal connection strength between issues on the chart.

29. The system of claim 28, further comprising:
a sort module for automatically sorting issue boxes displayed on the chart based, at least in part, on said causal connection strength.

30. The system of claim 21, wherein said user input module receives user input specifying importance of issues on the chart.

31. The system of claim 30, further comprising:
a sort module for automatically sorting issue boxes displayed on the chart based, at least in part, on said importance.

32. The system of claim 21, wherein said linkage module displays issues in chains, wherein the chains are based on causal connections among issues.

33. The system of claim 32, wherein linkage module displays an issue with only outgoing arrows at the chain top, so as to indicate the issue is causing other issues.

34. The system of claim 32, wherein said linkage module displays an issue with only incoming arrows at the chain bottom, so as to indicate the issue is symptom caused by other issues.

35. The system of claim 32, further comprising:
a theme module for displaying and storing a subset of the chart based on causal connections among issues.

36. The system of claim 21, wherein said shortcuts module restores the connecting arrow in response to user input for undoing removal of such connecting arrows.
